(19) United States
(12) Patent Application Publication
(10) Pub. No.: US 2010/0154000 A1
(43) Pub. Date: Jun. 17, 2010

(54) SYSTEMS AND METHODS FOR PROVIDING REAL-TIME SERVICES IN AN INTERACTIVE TELEVISION PROGRAM GUIDE APPLICATION

(75) Inventors: Douglas B. Macrae, Weston, MA (US); Thomas E. Westberg, Stow, MA (US); Thomas E. Ward, Weston, MA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties Inc., Tulsa, OK (US)

(21) Appl. No.: 12/556,940

(22) Filed: Sep. 10, 2009

Related U.S. Application Data
(63) Continuation of application No. 10/717,271, filed on Nov. 18, 2003, now abandoned.
(60) Provisional application No. 60/427,521, filed on Nov. 18, 2002.

(51) Int. Cl. H04N 5/445

(52) U.S. Cl. 725/41; 725/40

(57) ABSTRACT

An interactive television program guide application is provided that displays real-time information to a user. The interactive television program guide application may display alerts for indicating to the user the availability of real-time information. The interactive television program guide application may also display program listings with real-time information. In response to the user selecting a program listing, the interactive television program guide application may provide the user with an indication that real-time content related to the selected listing is available. In some embodiments, the real-time content is not the program corresponding to the selected program listing.

### CROSS REFERENCE TO RELATED APPLICATIONS

This application is a continuation of U.S. patent application Ser. No. 10/717,271, filed Nov. 18, 2003, which is a non-provisional application claiming the benefit of U.S. provisional patent application No. 60/427,521, filed Nov. 18, 2002, which is hereby incorporated by reference herein in its entirety.

### BACKGROUND OF THE INVENTION

This invention relates to interactive television applications and, more particularly, to interactive television program guide applications that provide real-time services to users.

Interactive television systems are known to provide interactive television program guide applications. An interactive television program guide application may be configured to provide a number of interactive features such as television program listings, video-on-demand services, web-browsing services, games, home shopping, and other interactive features, to the user.

These interactive television program guide applications may also be capable of providing real-time services to users. However, given the potentially large number of available real-time services, it is difficult to provide real-time services in such a manner that a user will easily access real-time information of interest.

Accordingly, it would be desirable to provide an interactive television program guide application with improved displays for providing real-time information to the user.

### SUMMARY OF THE INVENTION

In accordance with the present invention, an interactive television program guide application is provided with improved displays for providing real-time information to the user.

In some embodiments, the interactive television program guide application may provide improved listings displays that have real-time information, such as, for example, sports scores, news, weather, and any other suitable real-time information.

In some embodiments, in response to the user highlighting a listing having real-time information, the interactive television program guide application may display a video window that includes a video clip relating to the highlighted listing. The video clip may be selectable by the user. In response to the user selecting the video clip, the interactive television program guide application may display the program associated with the video clip. For example, the interactive television program guide application may provide the user with a plurality of listings relating to basketball games. In response to highlighting the “Celtics vs. Knicks” basketball game, the interactive television program guide application may provide the user with a video clip of the selected game in a video window. In response to the user selecting the video clip, the interactive television program guide application may provide the user with the “Boston vs. Celtics” game or any other program related to the highlighted listing.

In some embodiments, the interactive television program guide application may provide the user with alerts for receiving real-time information, for example, while the user is watching a program. In some embodiments, the interactive television program guide application may provide the user with an opportunity to designate at least one type of available real-time content as a preferred real-time content type. For example, the user may designate a specific sports team as a preferred real-time content type. In response to designating preferred real-time content, the interactive television program guide application may automatically display an alert that real-time information of the preferred real-time content type is available. For example, if the user indicates that the user wishes to receive real-time information (e.g., news, scores, etc.) relating to the “Boston Celtics,” the interactive television program guide application may provide the user with an alert when the Boston Celtics scores a point during a game.

The alert may be displayed as an overlay upon the currently viewed program, or the program may be resized to provide an area on the screen in which to display the alert without obscuring the program. In some embodiments, the alert may be selectable. In response to the user selecting the alert, the interactive television program guide application may display the real-time information. For example, the interactive television program guide application may display the updated score of the related sporting event and other data (e.g., game statistics, a breakdown of the game, etc.).

In some embodiments, the interactive television program guide application may allow the user to access real-time content relating to the real-time information that is displayed in the program listings. The interactive television program guide application may provide the user with an indication that real-time content is available. In this embodiment, the real-time content is different from the program corresponding to the program listing. For example, real-time content related to a sports game may be a replay, a highlight, a post-game press conference, a television program discussing the sports game, or any other suitable real-time content. The interactive television program guide application may display the real-time content in response to the user selecting the indication.

In some embodiments, the interactive television program guide application may provide the user with improved program listing displays that include information windows that are part of the improved program listing displays and that do not obstruct the other program listings. The interactive television program guide application may provide the information windows in response to receiving an indication from the user that the user wishes to obtain additional information relating to the highlighted program listing. The highlighted program listing may be expanded to insert the information window within the highlighted program listing. In some embodiments, the program listings below the selected program listing may be shifted downwards and/or removed to accommodate the size of the information window without obscuring other program listings.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, in which:

FIG. 1 is a diagram of an illustrative program guide data delivery system in accordance with various embodiments of the present invention.

FIG. 2 is a diagram of an illustrative interactive television system in accordance with various embodiments of the present invention.

FIG. 3 is a diagram of illustrative user television equipment in accordance with various embodiments of the present invention.

FIG. 4 is a diagram of additional illustrative user television equipment in accordance with various embodiments of the present invention.

FIG. 5 is a diagram of an illustrative remote control in accordance with various embodiments of the present invention.

FIG. 6 is a diagram of illustrative user computer equipment in accordance with various embodiments of the present invention.

FIG. 7 is a diagram of illustrative user equipment in accordance with various embodiments of the present invention.

FIG. 8 is an illustrative program listing screen that may be provided to the user in accordance with various embodiments of the present invention.

FIG. 9 is an illustrative program listing screen that includes an information window in accordance with various embodiments of the present invention.

FIG. 10 shows two orientations of an illustrative screen in accordance with various embodiments of the present invention.

FIGS. 11-13 are illustrative program screens that may be provided to the user in response to invoking the interactive television program guide application in accordance with various embodiments of the present invention.

FIGS. 14 and 15 are illustrative program screens that have progress bars in accordance with various embodiments of the present invention.

FIG. 16 is an illustrative program screen in accordance with various embodiments of the present invention.

FIGS. 17-23 are illustrative listing screens that include real-time sports information in accordance with various embodiments of the present invention.

FIGS. 24A-24C are illustrative program screens for providing the user with a real-time alert while the user is watching a program in accordance with various embodiments of the present invention.

FIG. 25 is an illustrative alert setup screen that may be provided to the user in accordance with various embodiments of the present invention.

FIGS. 26-30 are illustrative new listings screens that include real-time information in accordance with various embodiments of the present invention.

FIGS. 31A-C are illustrative program screens for providing the user with a real-time news alert while the user is watching a program in accordance with various embodiments of the present invention.

FIG. 32 is an illustrative program screen for providing the user with a program that is discussing the real-time information in accordance with various embodiments of the present invention.

FIGS. 33-37 are illustrative listing screens that provide the user with real-time weather information in accordance with various embodiments of the present invention.

FIGS. 38 and 39 are illustrative program screens that provide the user with a real-time weather alert while the user is watching a program in accordance with various embodiments of the present invention.

FIG. 40 is an illustrative listing screen that provides the user with real-time weather information relating to an alert in accordance with various embodiments of the present invention.

FIG. 41 shows an illustrative method for providing the user with a program corresponding to a video clip in accordance with various embodiments of the present invention.

FIG. 42 shows an illustrative method for providing the user with an alert that real-time information is available in accordance with various embodiments of the present invention.

FIG. 43 shows an illustrative method for providing the user with an indication that real-time content relating to a listing is available in accordance with various embodiments of the present invention.

FIG. 44 shows an illustrative method for displaying an information window with program listings in accordance with various embodiments of the present invention.

### DETAILED DESCRIPTION OF THE PREFERRED EMBODIMENTS

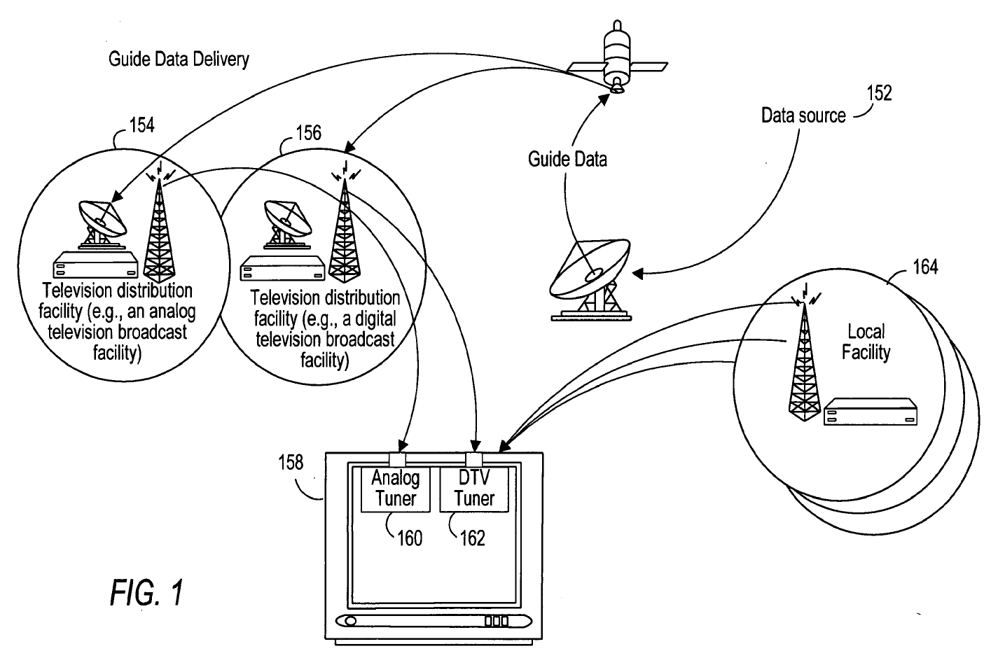

For the purposes of illustration, an illustrative system for receiving program guide data from multiple television distribution facilities is shown in FIG. 1. Data source 152 may provide program schedule information and other data (e.g., advertisements, real-time data, etc.) to television distribution facilities 154 and 156 over a communications path for distribution to associated user equipment 158. For example, television distribution facility 154 may be an analog television broadcast facility that transmits analog programming and program information. Analog tuner 160 of user equipment 158 may receive the analog programming and program information. Similarly, television distribution facility 156 may be a digital television broadcast facility that transmits digital programming and program information which are then received by digital tuner 162 of user equipment 158. User equipment 158 may have multiple tuners to, for example, accommodate simultaneous watch and record functions.

If desired, data sources may be located at facilities separate from data source 152, such as at local facility 164. Local facility 164 may be any suitable facility for obtaining data particular to a localized region and providing the data to user equipment 158 by, for example, a communications link to digital tuner 162. Local facility 164 may be, for example, a local weather station that measures weather data, a local newspaper that obtains local high school and college sporting information, or any other suitable provider of information. Local facility 164 may be a local business with a computer for providing a main facility with, for example, local ski reports, fishing conditions, menus, etc., or any other suitable provider of information.

In some embodiments, local facility 164 may be used to transmit program guide data that supplements unavailable or incorrect program schedule information. Local facility 164 may supplement the unavailable or incorrect program guide information using, for example, the Program and System Information Protocol (PSIP) to transmit the program guide data to digital tuner 162. In some embodiments, operators at local facility 164 may correct errors in the program guide data by delivering the corrected program guide data using PSIP to digital tuner 162. For example, local facility 164 may update the program guide data if the data contains a typographical error or if the program schedule information has recently been changed and has not been updated in the guide data.

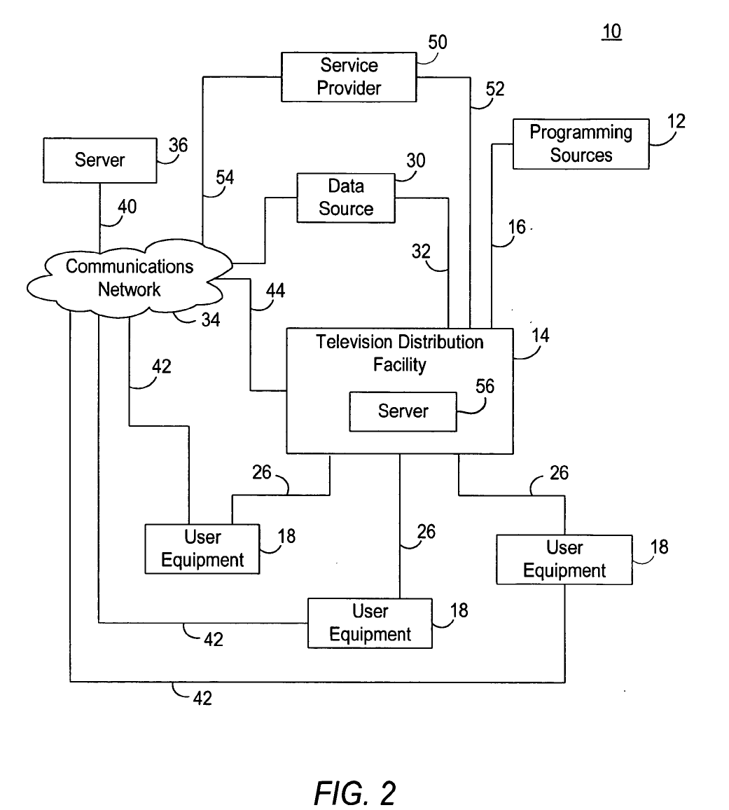

For purposes of illustration, an illustrative interactive television application system 10 in accordance with an embodiment of the present invention is shown in FIG. 2. Content such as television programming and other media, such as digital music, may be provided from programming sources 12 to television distribution facilities such as television distribution facility 14 using communications path 16. Programming sources 12 may be any suitable sources of television and music programming and other information, such as television and music production studios, etc.

Television distribution facility 14 may be a cable system headend, a satellite television distribution facility, a television broadcast facility, or any other suitable facility for distributing television and music programming to users. There are typically numerous television distribution facilities 14 in system 10, but only one is shown in FIG. 2 to avoid overcomplicating the drawings.

Communications path 16 may be a satellite path, a fiber-optic path, a cable path, or any other suitable wired or wireless communications paths or a combination of such paths.

Television distribution facility 14 may be connected to various user equipment devices 18. Such user equipment 18 may, for example, be located in the homes of users. User equipment 18 may receive television and music programming and other information from television distribution facility 14 over communications path 26. User equipment 18 may also transmit signals to television distribution facility 14 over path 26. Path 26 may be cables or other wired connections, or wireless connections for broadcast or satellite links.

Data source 30 may include a program listings database that is used to provide the user equipment 18 with information for the interactive television program guide, such as scheduled broadcast times, titles, channels, ratings information (e.g., parental ratings and critic's ratings), detailed title descriptions, genre or category information (e.g., sports, news, movies, etc.), information on actors and actresses, running times, etc. Data source 30 may also be used to provide advertisements (e.g., program guide advertisements and advertisements for other interactive television applications).

Data source 30 may provide program schedule information and other data to television distribution facility 14 over communications path 32 for distribution to the associated user equipment over path 26. Communications path 32 may be any suitable communications path such as a satellite communications path or other wireless path, a fiber-optic or other wired communications path, a path that supports Internet communications, a combination of such paths, etc. Data source 30 may provide program schedule information and other data to the user at user equipment 18 over path 38, communications network 34, and path 42. Path 42 may be a wired path such as a telephone line, a cable path, a fiber-optic path, a satellite path, a wireless path, a combination of such paths, or any other suitable path.

Data source 30 may include real-time data sources that gather information such as. current sports scores for games in progress, real-time game statistics, game delay information, game availability information (i.e., information on whether a given game is blocked out or not), real-time stock quotes or other financial information, real-time news, current weather information, or any other suitable real-time data.

Real-time data as the sports scores for current sporting events may be obtained directly from a real-time data feed from data source 30. The data feed may be buffered if necessary, for example, by storing data from data source 30 in a database. This allows sports scores and other real-time data to be retrieved rapidly by the program guide when needed. The potential latency period associated with obtaining real-time data from a real-time data feed may be reduced by storing the real-time data in a database maintained by the program guide where it may be accessed almost immediately by the program guide. Storing real-time data in this database also allows sports scores, news, weather, stock quotes, and other such real-time data to be stored for a short period of time, so that the user may access this information with the program guide. As an example, sports scores may be retained even after a given sporting event has concluded, so that the user may be provided with the final score in a program guide display.

Although data source 30 is drawn as an individual box in FIG. 2, data source 30 and the other system components of FIG. 2 may be provided using equipment at one or more locations. System components are drawn as single boxes in FIG. 2 to avoid over-complicating the drawings.

An on-line program guide and other interactive television services may be provided using a server connected to communications network 34 such as server 36. Server 36 may receive program schedule information and other data from data source 30 via communications path 38, communications network 34, and communications path 40. Paths 38 and 40 may be satellite paths, fiber-optic paths, wired paths, etc. Communications network 34 may be any suitable communications network, such as the Internet, the public switched telephone network, a packet-based network, etc.

User equipment 18 may access on-line program guide information and other information from server 36 via communications path 42. User equipment 18 may also access the on-line program guide and other services on server 36 via communications path 26, television distribution facility 14, and communications path 44. For example, a cable modem or other suitable equipment may be used by user equipment 18 to communicate with television distribution facility 14. Television distribution facility 14 may communicate with communications network 34 over any suitable path 44, such as a wired path, a cable path, fiber-optic path, satellite path, a combination of such paths, etc.

The data distribution technique that is used to distribute data to user equipment 18 on path 26 may depend on the type of information that is being distributed. For example, text and graphics may be distributed over an out-of-band channel using an out-of-band modulator, distributed using a digital-in-band channel, or distributed in the vertical blanking interval lines of one of the channels. Video information may also be distributed in this way, although large quantities of video information may be more efficiently distributed using one or more digital channels or streams on path 26. Such digital channels or streams may also be used for distributing text and graphics.

Program guide application functions and the functions of other interactive television applications may be supported using server 36 and other servers connected to communications network 34 such as server 56. Interactive television applications may also be supported by servers or other suitable equipment at one or more service providers such as service provider 50. For example, a home shopping service may be supported by a service provider such as service provider 50 that has sales representatives, order fulfillment facilities, account maintenance facilities, and other equipment for supporting interactive home shopping features. A home shopping application that is implemented using the user equipment 18 may be used to access the service provider to provide these features to the user. The user equipment 18 may access service provider 50 via television distribution facility 14 and communications path 52 or via communications network 34 and communications path 54. Communications paths such as paths 52 and 54 may be any suitable paths, such as wired paths, cable paths, fiber-optic paths, satellite paths, a combination of such paths, etc.

Another example of an interactive television application is a home banking application. A home banking service may be supported using personnel at facilities such as service provider 50. An interactive home banking application that is implemented using the user equipment may access the home banking service via television distribution facility 14 and communications path 52 or via communications network 34 and communications path 54.

If desired, an interactive television application such as a network-based video recorder or a video-on-demand application may be supported using server 56, server 36, or equipment at service provider 50. Video-on-demand content and video recorded using a network-based video recorder arrangement may be stored on server 56 or server 36 or at service provider 50 and may be provided to the user equipment when requested by users. An interactive television application may be used to support the functions of a personal video recorder (sometimes called a digital video recorder) that is implemented using user equipment 18. Illustrative equipment that may be used to support personal video recorder functions include specialized personal video recorder devices, integrated receiver decoders (IRDs), set-top boxes with integrated or external hard drives, or personal computers with video recording capabilities.

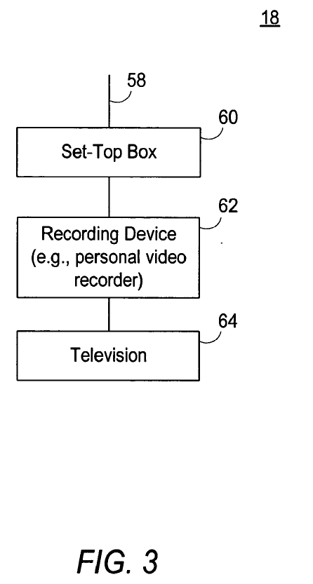

Although television distribution facility 14 is drawn as an individual box in FIG. 2, television distribution facility 14 and the other system components of FIG. 2 may be provided using equipment at one or more locations. System components are drawn as single boxes in FIG. 2 to avoid over-complicating the drawings. For example, set-top box 60 (FIG. 3) may receive program guide data from multiple television distribution facilities.

FIGS. 3-7 show illustrative arrangements of user equipment 18. FIG. 3 shows a set-top box arrangement. In this arrangement, input/output 58 may be connected to communication paths such as paths 26 and 42. Input/output functions may be provided by one or more wires or communications paths, but are shown as a single path in FIG. 3 to avoid overcomplicating the drawing. Television programming and other information may be received using input/output 58. Commands and requests and other information from the user may also be transmitted over input/output 58.

Set-top box 60 may be any suitable analog or digital set-top box (e.g., a cable set-top box). Set-top box 60 may contain an analog tuner for tuning to a desired analog television channel. Set-top box 60 may also contain digital decoding circuitry for receiving digital television and music channels. Both analog and digital channels may be included if desired. Multiple tuners of each may be provided (e.g., to handle simultaneous watch and record functions). Set-top box 60 may be an integrated receiver decoder (IRD) that handles satellite television. If desired, set-top box 60 may have circuitry for handling cable, over-the-air broadcast, and satellite content. Set-top box 60 may include a storage device (e.g., a digital storage device such as a hard disk drive) for providing recording capabilities. Set-top box 60 may also be connected to a recording device 62 such as a video cassette recorder, personal video recorder, or other device or devices with storage capabilities.

In some embodiments, set-top box 60 may include both an analog tuner and a digital tuner. The analog tuner of set-top box 60 may be used to tune to a desired analog television channel (e.g., from an analog programming source). The digital tuner of set-top box 60 may be used to receive digital television (e.g., from a digital programming source).

Referring back to FIG. 3, set-top box 60 contains a processor (e.g., a microcontroller or microprocessor or the like) that is used to execute software applications. The processor described as being located within set-top box 60 is omitted from FIG. 3 in order to avoid unnecessarily complicating the figure. Set-top box 60 may contain memory such as random-access memory for use when executing applications. Nonvolatile memory may also be used (e.g., to launch a boot-up routine and other instructions). Hard disk storage in box 60 or in recording device 62 may be used to back up data and to otherwise support larger databases and storage requirements than may be supported using random-access memory approaches.

Set-top box 60 may have infrared (IR) or other communications circuitry for communicating with a remote control or wireless keyboard. Set-top box 60 may also have dedicated buttons and a front-panel display. The front-panel display may, for example, be used to display the current channel to which the set-top box is tuned.

Set-top box 60 may also have communications circuitry such as a cable modem, an integrated services digital network (ISDN) modem, a digital subscriber line (DSL) modem, a telephone modem, wireless modem, etc. for communications with other equipment. Such communications may involve the Internet or any other suitable communications networks or paths. If desired, the components of set-top box 60 may be integrated into other user equipment (e.g., a television or videocassette recorder).

Recording device 62 may be used to record videos provided by set-top box 60. For example, if set-top box 60 is tuned to a given television channel, the video signal for that television channel may be passed to recording device 62 for recording on a videocassette, compact disc, digital video disk, or internal hard drive or other storage device. Recording device 62 may have communications circuitry such as a cable modem, an ISDN modem, a DSL modem, a telephone modem, etc. for communications with other equipment. Such communications may involve the Internet or any other suitable communications networks or paths. The components of recording device 62 may be integrated into other user equipment (e.g., a television, stereo equipment, etc.).

Recording device 62 may be controlled using a remote control or other suitable user interface. If desired, video recorder functions such as start, stop, record, etc. and other functions for device 62 may be controlled by set-top box 60. For example, set-top box 60 may control recording device 62 using infrared commands directed toward the remote control inputs of recording device 62 or set-top box 60 may control recording device 62 using other wired or wireless communications paths between box 60 and device 62.

The output of recording device 62 may be provided to television 64 for display to the user. If desired, multiple recording devices 62 or no recording device 62 may be used. If recording device 62 is not present or is not being actively used, the video signals from set-top box 60 may be provided directly to television 64. Any suitable television or monitor may be used to display the video. In the equipment of FIG. 3 and the other equipment of system 10, the audio associated with various video items is typically distributed with those video items and is generally played back to the user as the videos are played.

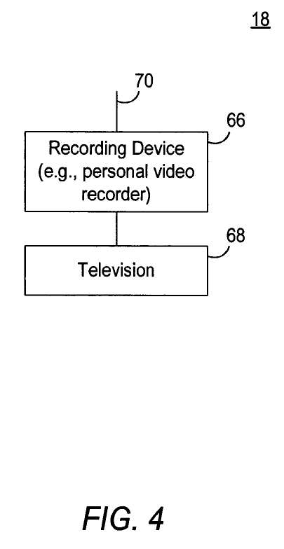

Another illustrative arrangement for user equipment 18 is shown in FIG. 4. In the example of FIG. 4, user equipment 18 includes a recording device 66 such as a digital video recorder (e.g., a personal video recorder (PVR)) that uses a hard disk or other storage for recording video or may be a digital video disc recorder, compact disc recorder, videocassette recorder, or other suitable recording device. User equipment 18 of FIG. 4 may also include a television 68. Input/output 70 may be connected to communications paths such as paths 26 and 42. Television programming and other information may be received using input/output 70. Commands and requests and other information from the user may be transmitted over input/output 70.

Recording device 66 may contain at least one analog tuner for tuning to a desired analog television channel (e.g., multiple tuners may be provided). Recording device 66 may also contain digital decoding circuitry for receiving digital television and music channels. If desired, recording device 66 may contain circuitry for handling both analog and digital channels. Recording device 66 also contains a processor (e.g., multiple tuners may be provided, a microcontroller or microprocessor or the like) that is used to execute software applications. Recording device 66 may contain memory such as random-access memory for use when executing applications. Nonvolatile memory may also be used to store a boot-up routine or other instructions. The hard disk and other storage in recording device 66 may be used to support databases (e.g., program guide databases or interactive television application databases). The hard disk or other storage in recording device 66 may also be used to record video such as television programs or video-on-demand content or other content provided to recording device 66 over input/output 70.

Recording device 66 may have IR communications circuitry or other suitable communications circuitry for communicating with a remote control. Recording device 66 may also have dedicated buttons and a front-panel display. The front-panel display may, for example, be used to display the current channel to which the recording device is tuned.

Recording device 66 may also have communications circuitry such as a cable modem, an ISDN modem, a DSL modem, a telephone modem, a wireless modem, etc. for communications with other equipment. Such communications may involve the Internet or other suitable communications networks or paths.

If desired, recording device 66 may include a satellite receiver or other equipment that has wireless communications circuitry for receiving satellite signals.

Recording device 66 of FIG. 4 or recording device 62 of FIG. 3 may record video while previously recorded video is being played back on television 68 or 64. This allows users to press a pause button during normal television viewing. When the pause button is pressed, the current television program is stored on the hard disk of digital video recorder 66. When the user presses play, the recorded video may be played back. This arrangement allows the user to seamlessly pause and resume television viewing. Recording device 66 and 62 may also be used to allow a user to watch a previously-recorded program while simultaneously recording a new program.

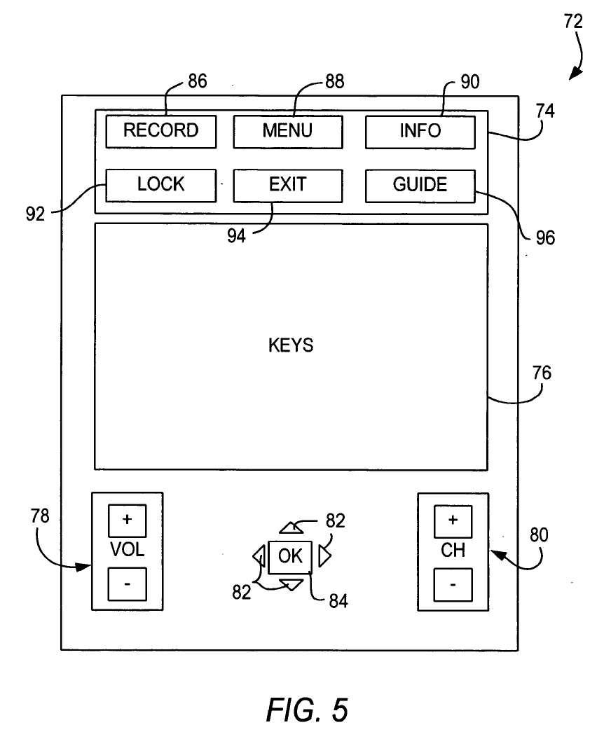

An illustrative remote control 72 for operating user equipment 18 is shown in FIG. 5. Remote control 72 may have function keys 74 and other keys 76 such as keypad keys, power on/off keys, pause, stop, fast-forward and reverse keys, etc. Volume up and down keys 78 may be used for adjusting the volume of the audio portion of a video. Channel up and down keys 80 may be used to change television channels and to access content on virtual channels. Cursor keys 82 may be used to navigate on-screen menus. For example, cursor keys 82 may be used to position an on-screen cursor, indicator, or highlight (sometimes all generically referred to herein as a highlight or highlight region) to indicate interest in a particular option or other item on a screen displayed by the interactive television application.

An OK key 84 (sometimes called a select or enter key) may be used to select on-screen options that the user has highlighted.

Keys 74 may include a record key 86 for initiating recordings. Menu button 88 may be used to direct the interactive television program guide application to display a menu on the user's display screen (e.g., on television 64 or 68 or on a suitable monitor or computer display). Info button 90 may be used to direct the interactive television application to display an information display screen. If the user has highlighted a particular program listing, for example, selecting the info button 90 may direct the interactive television application to provide additional program schedule information related to that program listing (e.g., a program summary, actor information, etc.).

Lock button 92 may be used to modify access privileges. For example, a parent may use lock button 92 or on-screen options to establish parental control settings for the interactive television application. The parental control settings may be time-based settings (e.g., to prevent a child from watching television during a particular time block such as from 3:00 PM to 5:00 PM). The parental control settings may also be used to block programming based on rating, channel, program title, etc. A locked or blocked program is typically not viewable until the interactive television application is provided with a suitable personal identification number (PIN). Once this PIN has been entered, the interactive television program will unlock the user's equipment and allow the locked content to be accessed.

Exit button 94 may be used to exit the interactive television application or to exit a portion of the interactive television application. Guide button 96 may be used to invoke the interactive television application.

The keys shown in FIG. 5 are merely illustrative. Other keys or buttons may be provided if desired. For example, a music button may be used to access music with the interactive television application. An edit button may be used to edit stored content (e.g., to remove commercials, remove portions of a video, etc.). Alphanumeric buttons may be used to enter alphanumeric characters. A last or back button may be used to browse backward in the interactive television application (e.g., to return to a previous channel or display screen). Video recorder function buttons such as a play button, pause button, stop button, rewind button, fast-forward button, and record button, may be used to control video recorder functions (local or network-based) in system 10. A help key may be used to invoke help functions such as context-sensitive on-screen help, etc.

It should also be noted that the set-top box arrangement of FIG. 3 and the digital video recorder set-top box arrangement of FIG. 4 are merely illustrative. For example, user equipment may be based on a WebTV box, a personal computer television (PC/TV), or any other suitable television equipment arrangement. If desired, the functions of components such as set-top box 60, digital video recorder 66, a WebTV box, or PC/TV or the like may be integrated into a television or personal computer or other suitable device.

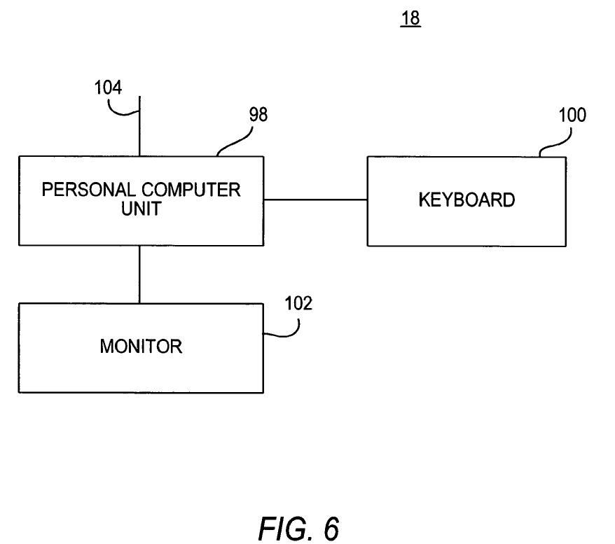

FIG. 6 shows a personal computer based arrangement for user equipment 18. In the arrangement of FIG. 6, personal computer unit 98 may be controlled by the user using keyboard 100 or other suitable user input device, such as a trackball, mouse, touch pad, touch screen, voice recognition system, a remote control such as remote control 72 of FIG. 5, etc. Video content such as television programming and interactive television application display screens may be displayed on monitor 102. Television programming, video-on-demand content, video recordings played back from a network-based video recorder, and other information may be received from paths 26 and 42 (FIG. 2) using input/output 104. The user may also send commands and other information used during interactions with the interactive television application and system 10 over input/output line 104.

Personal computer unit 98 may contain a television or video card such as television tuner card for decoding analog and digital television channels and for handling streaming video content. Multiple video cards (e.g., tuner cards) may be provided if desired. An illustrative television tuner card that may be used may contain an analog television tuner for tuning to a given analog channel and digital decoding circuitry for filtering out a desired digital television or music channel from a packetized digital data stream. Any suitable card or components in computer unit 98 may be used to handle video and other content delivered via input/output line 104 if desired.

Personal computer unit 98 may contain one or more processors (e.g., microprocessors) that are used to run the interactive television application or a portion of the interactive television application.

Video recording functions may be provided by the interactive television application in a personal video recorder arrangement or a network-based video recorder arrangement, or any other suitable arrangement.

In a personal video recorder arrangement, storage in personal computer unit 98 may be a hard drive, digital versatile disc recordable (DVD-R) drive, digital versatile disc rewritable (DVD-RW) drive, compact disc recordable (CD-R) drive, compact disc rewritable (CR-RW) drive, or other suitable storage device or devices for storing video and other content. The interactive television application and personal computer unit 98 may use this storage to provide the functions of a personal video recorder.

Network-based video recording functions may be provided using a combination of user equipment 18 and network equipment. Network equipment may be, for example, server 56, server 36, or equipment at service providers such as service provider 50 of FIG. 2. Video recording functions may be provided by storing copies of television programs and other video content on a remote server (e.g., server 56 or server 36 of FIG. 2) or other network-based equipment such as equipment at a service provider such as service provider 50.

Video recordings may be made in response to user commands that are entered at user equipment 18. In a personal video recorder arrangement, the interactive television application may be used to record video locally on the user equipment in response to the user commands. In a network-based video recorder arrangement, the interactive television application may be used to record video or to make virtual recordings on network equipment such as server 36, 56, or equipment at service provider 50 in response to the user commands. The user commands may be provided to the network equipment over the communications paths shown in FIG. 2. The personal video recorder arrangement and the network-based video recorder arrangement can support functions such as fast-forward, rewind, pause, play, and record.

To avoid unnecessary duplication in a network-based video recorder environment, the system 10 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area.

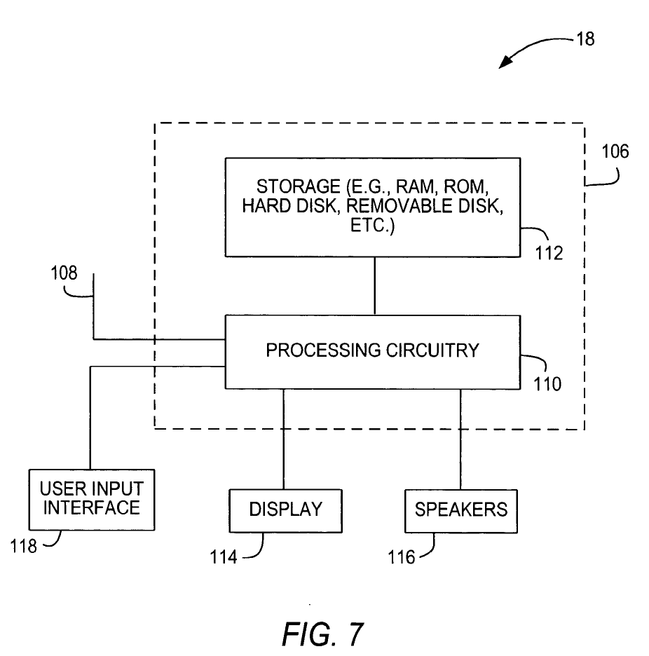

FIG. 7 shows a more generalized embodiment of illustrative user equipment 18. Control circuitry 106 is connected to input/output 108. Input/output 108 may be connected to one or more communications paths such as paths 26 and 42 of FIG. 2. Television and music programming may be received via input/output 108 (e.g., from programming sources 12, servers or other equipment such as server 36, service providers such as service provider 50, and television distribution facility 14). Program schedule information for an interactive television application may be received from data source 30 via input/output 108. Input/output 108 may also be used to receive information transmitted by data source 30 for other interactive television applications. The user may use control circuitry 106 to send commands, requests, and other suitable information using input/output 108.

Control circuitry 106 may be based on any suitable processing circuitry 110 such as processing circuitry based on one or more microprocessors, microcontrollers, digital signal processors, programmable logic devices, etc. Storage 112 may be any suitable memory (e.g., random-access memory and read-only memory), hard drives, DVD drives, CD drives, or other suitable storage devices. Tuning circuitry (not shown) such as one or more analog tuners, one or more MPEG-2 decoders or other digital video circuitry, or any other suitable tuning or video circuits or combinations of such circuits may also be included as part of circuitry 106. Encoding circuitry (not shown) (e.g., for converting over-the-air or cable analog signals to MPEG signals for storage) may also be provided. Tuning and encoding circuitry may be used by the user equipment to receive and display or play or record a particular television or music channel or other desired audio and video content (e.g., video-on-demand content or requested network-based or local video recorder playback). Television programming and other video and on-screen options and information may be displayed on display 114. Display 114 may be a monitor, a television, or any other suitable equipment for displaying visual images. Speakers 116 may be provided as part of a television or may be stand-alone units. Digital music and the audio component of videos displayed on display 114 may be played through speakers 116.

Users may input user commands to control circuitry 106 using user input interface 118. The user input interface 118 may be any suitable user interface, such as a mouse, trackball, keypad, keyboard, touch screen, touch pad, voice recognition interface, remote control, etc. Control circuitry 106 may then direct other circuitry or peripherals (e.g., display 114) to take actions in accordance with programming instructions stored on storage 112.

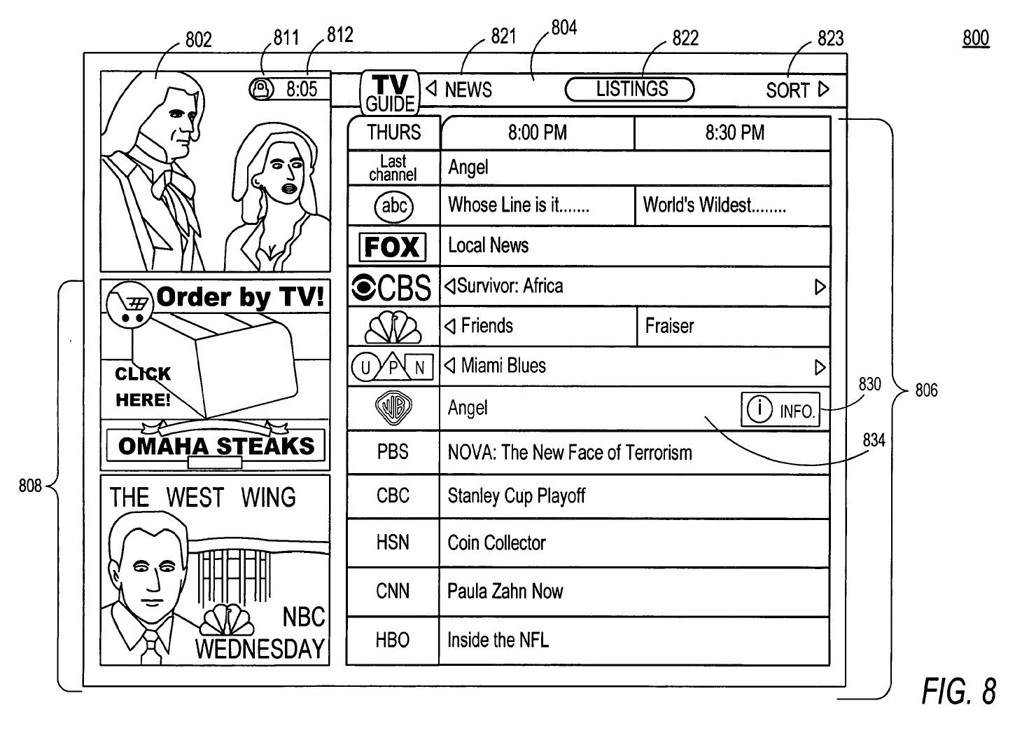

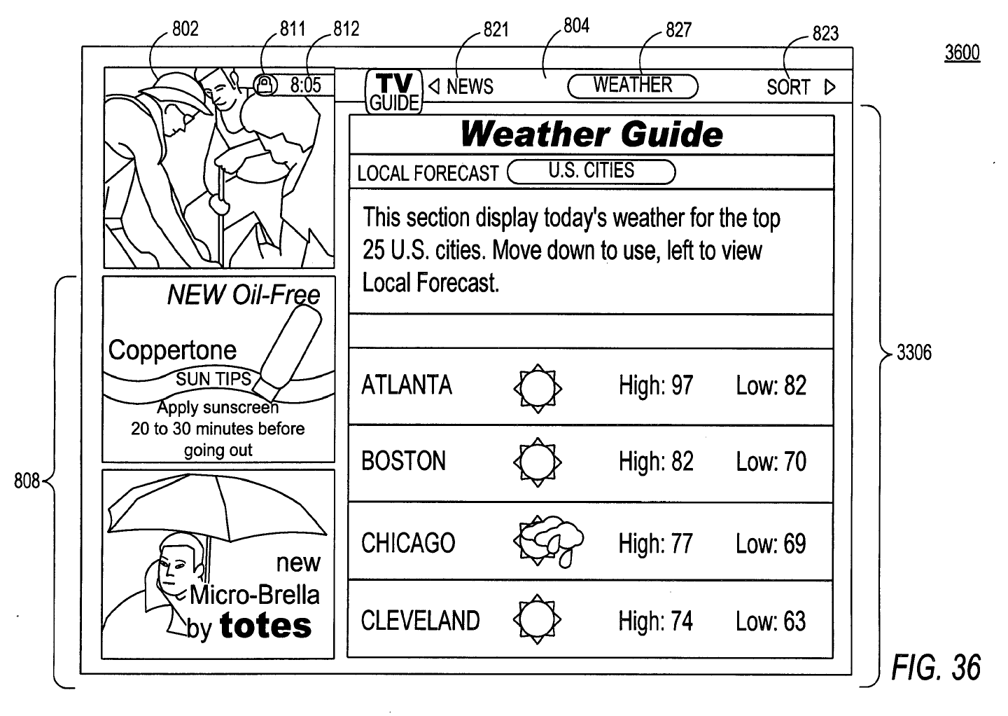

An interactive television program guide having various interactive television program guide interface screens may be provided to assist a user in selecting television programs. Illustrative interactive television program guide interface screens are described, for example, in Ellis U.S. patent application Ser. No. 10/306,175, filed Nov. 25, 2002, which is hereby incorporated by reference herein in its entirety. Other examples of program guide screens, such as improved listing screens, in interactive television program guide applications are described, for example, in Macrae et al. U.S. provisional patent application No. 60/427,521, filed Nov. 18, 2002, which is hereby incorporated by reference herein in its entirety. FIGS. 8-40 show such screens. While the examples of FIGS. 8-40 are shown as television screens in accordance with the present invention, it will be understood that various other types of screens, such as computer screens, screens of personal digital devices, or any other suitable display arrangement, may be used.

As the number of available television programs grows, it becomes increasingly more confusing and burdensome for a user to find listings for desirable programs. One approach for mitigating this problem is to provide the user with an interactive television program guide application that displays additional information, such as detailed program information, real-time information, and a video clip corresponding to a given listing. For example, the interactive television program guide application may provide the user with information by inserting an information window into the selected listing that has been expanded to accommodate the information window without obstructing other program listings. In another example, the interactive television program guide application may provide the user with a video clip of the selected program listing in a region, such as an unused panel advertisement area, that does not obstruct the program listings.

FIG. 8 shows an illustrative program listing screen that may be provided by the interactive television program guide application in accordance with various embodiments of the present invention. As shown in FIG. 8, display screen 800 and program guide display screens generally may include a video window 802, a service navigation bar 804, a listings area 806, and a panel area 808. Video window 802 contains a video clip. In some embodiments, the video clip may correspond to the currently highlighted program listing in listings area 806. Alternatively, the video clip may be associated with a program that is related to the currently highlighted program listing (e.g., a program in the same genre).

In some embodiments, the interactive television program guide application may allow the user to configure the content displayed in video window 802. The interactive television program guide application may display an icon, such as a lock icon 811, that indicates whether video window 802 is in a locked state or unlocked state. In response to the user placing video window 802 in a locked state (e.g., by pressing a pre-configured key on the remote control), icon 811 may be displayed as a padlock that is locked. When video window 802 is in a locked state, video window 802 may include a video for a specific program. In the example of FIG. 8, in response to the user selecting the program listing 834 corresponding to the program “Angel” and placing video window 802 in a locked state, the interactive television program guide application allows the user to browse through other program listings while continuing to view the video window corresponding “Angel.”

In some embodiments, the video clip displayed in video window 802 may be provided by one of the tuners at the user equipment. The tuner may be tuned to the channel broadcasting the program corresponding to the selected program listing. For example, in response to the user selecting the program listing “Angel,” the interactive television program guide application may direct one of the tuners to tune to “Angel” and provide the user with the currently broadcasted program in video window 802.

Alternatively, the video clip displayed in video window 802 may be retrieved from a database (e.g., at a data source, at a television distribution facility, at a main facility, on the user's digital video recorder, etc.). For example, in response to the user selecting the program listing “Angel,” the interactive television program guide application may retrieve a video clip for the selected listing from the database. Upon retrieving the video clip, the interactive television program guide application may automatically playback the video clip in video window 802.

In some embodiments, the database may receive video clips and other information from the service provider. For example, a service provider may update the database by providing video clips for programs that have recently been broadcast. In another example, for upcoming programs, a service provider may transmit previews of the upcoming program or trailers to the database.

In some embodiments, the interactive television program guide application may retrieve video clips relating to programs that are about to be broadcast in anticipation of the user selecting a program listing for one of the upcoming programs. The interactive television program guide application may display the appropriate video clip in response to the user selecting the corresponding program listing. For example, the interactive television program guide application may retrieve video clips from the database for the upcoming programs “Fear Factor,” “7th Heaven,” and “Joe Millionaire” at 7:30 PM, before their 8:00 PM start times. In another example, the interactive television program guide application may retrieve video clips from the database for programs that the user is likely to watch or view program listings. In response to the user selecting the program listings for one of these programs, the corresponding video clip may be displayed immediately.

In some embodiments, in response to the user selecting a program listing, the interactive television program guide application may retrieve the corresponding video clip and play back the video clip as it is being retrieved from the database. For example, the interactive television program guide application may display a video clip as a streaming video (i.e., displayed as it is being retrieved).

Video window 802 may also be selectable by the user. In response to the user selecting video window 802, the interactive television program guide application may provide the user with the program corresponding to video window 802. For example, as shown in FIG. 8, video window 802 corresponds to the currently highlighted program listing. In response to the user selecting video window 802, the interactive television program guide application may provide the user with the program “Angel” (as shown in FIG. 11).

In some embodiments, video window 802 may display an image (e.g., a background image, photos, etc.) that is provided by the user. If the user provides multiple images, the interactive television program guide application may display one image after another in succession. Each image may be displayed for a pre-determined amount of time to create a slideshow of images. In response to the user placing the video window in an unlocked state, icon 811 may be displayed as a padlock that is unlocked. When video window 802 is in an unlocked state, the video displayed in video window 802 may correspond to the program listing currently selected by the user in listings area 806.

In addition, video window 802 and program guide display screens generally may also include a mail icon, a clock 812, and any other suitable display element. The mail icon may indicate whether the user has a message. Clock 812 may display the current local time.

Although video window 802 is shown in the upper left portion of screen 800, it should be noted that video window 802 may be displayed in any other suitable arrangement. For example, the interactive television program guide application may determine that a portion of panel area 808 is unused. In response, the interactive television program guide application may display video window 802 in the unused portion of panel area 808.

Panel area 808 may include one or more panel advertisements. These advertisements may be user-interactive and/or user-selectable, allow the user to order or purchase the subject of the advertisement, find more information about the subject of the advertisement, perform an action relating to the subject of the advertisement (such as record or add to a favorites list), or perform any other suitable action. It should be noted that panel area 808 and program guide display screen generally may also include, for example, other graphics, animations, selectable advertisements, or video windows. Any other suitable content, such as, for example, logos (e.g., MSO logos, network logos, or channel logos), and advertisements or promotions (e.g., advertisements for television programs, movies, pay-per-view events, products, services, etc.) may also be provided.

Service navigation bar 804 includes options for allowing the user to navigate to different services provided by the interactive television program guide application. These options may include a “News” service tab 821, a “Listings” service tab 822, a “Sort” service tab 823, a “Messages” service tab 824, a “Sports” service tab 825, a “Schedule” service tab 826, a “Weather” service tab 827, a “Setup” service tab 828, a “Play List” service tab, a “Search” service tab, and any other suitable service tabs. As shown in FIG. 8, the interactive television program guide application may display three service tabs in navigation bar 804. However, the service tabs may be displayed using any suitable display arrangement. The interactive television program guide application may allow the user to navigate through services by, for example, scrolling between service tabs. It will be understood that the interactive television program guide application may provide the user with other user interface constructs suitable for navigating through service tabs, such as drop-down menus, radio buttons, or push buttons.

In response to the user selecting one of the service tabs, the interactive television program guide application may display a display screen related to the selected tab in listings area 806. Listings area 806 may include listings and information associated with the listing (e.g., program title information and related program information). For example, in response to the user selecting “Listings” service tab 822, the interactive television program guide application may display program listings in listings area 806. In another example, in response to the user selecting “Sports” service tab 825, the interactive television program guide application may provide the user with a listing of sports scores.

As shown in FIG. 8, “Listings” service tab 822 is currently selected. In response to the user selecting “Listings” service tab 822 from service navigation bar 804, the interactive television program guide application may provide the user with listings area 806. Listings area 806 may include, for example, a plurality of selectable program listings. The program listings may be presented in a grid format with programs scheduled to be broadcast on the same channel being arranged in the same row and programs scheduled to be broadcast for the same time slot being arranged in the same column. Because only a limited number of program listings may be displayed simultaneously, the interactive television program guide application may allow the user to scroll through channels and times to view other program listings using, for example, the remote control.

In some embodiments, the interactive television program guide application may provide the user with an option to receive additional information for each of the program listings. For example, in FIG. 8, an “Info” button 830 is displayed in the currently selected program listing.

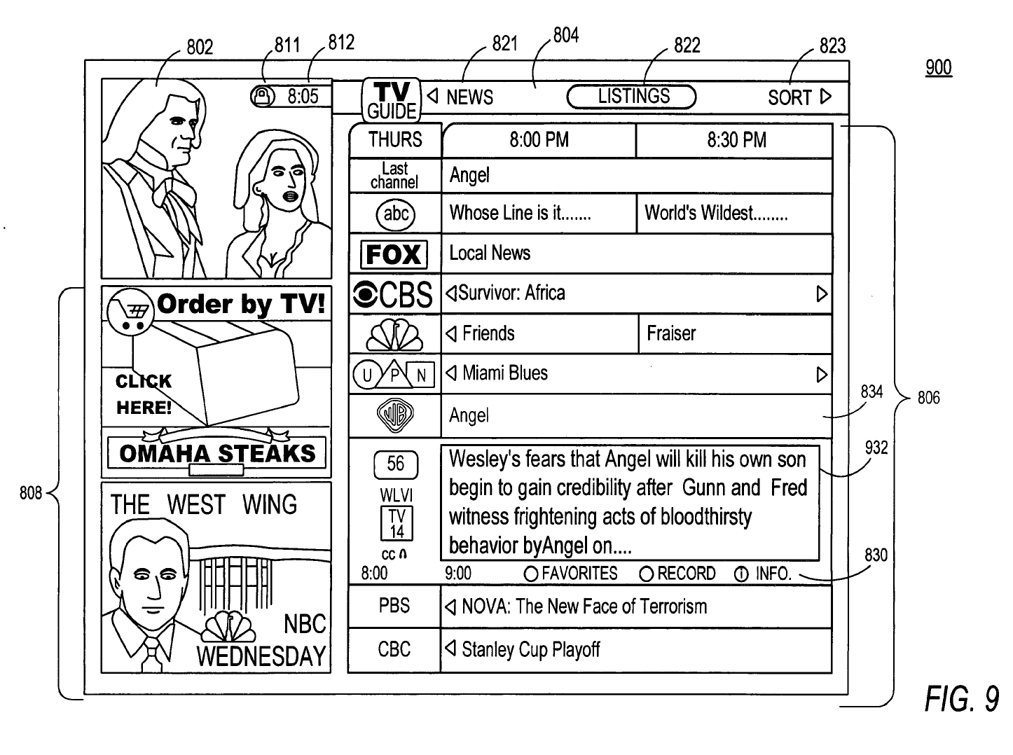

As shown in FIG. 9, in response to the user selecting “Info” button 830 using remote control 72 (FIG. 5), the interactive television program guide application may provide the user with an information window 932. In response to providing information window 932, the program listings that are displayed below the currently highlighted program listing may be adjusted such that information window 932 does not obstruct the view of the program listings. For example, a specific number of program listings may be removed (e.g., slide out) from listings area 802. In some embodiments, the arrangement of the program listings in listings area 802 may be adjusted based on the size of information window 932.

Information window 932 may be positioned within the highlighted program listing. For example, the highlighted program listing may expand to include information window 932 such that information window 932 does not obscure the program listings that are not selected. In response to the user highlighting a different program listing (e.g., by pressing the “UP” button on the remote control), information window 932 may move from within the current program listing to within the newly highlighted program listing.

In some embodiments, the interactive television program guide application may require that at least one program listing be displayed above and below the selected program listing. This may inform the user that additional program listings are available. For example, the user may attempt to select a program listing that is at the top of listings area 806 from the second listing position by, for example, pressing “UP” on the remote control. In response, the interactive television program guide application may shift the program listings downwards by one position to allow the user to select the program listing previously at the top of listings area 806, which has moved into the second position.

Alternatively, information window 932 may be positioned about the center of listings area 806. In response to the user selecting a different program listing, information window 932 may remain in the same position and the program listings may shift accordingly, thereby allowing the user to maintain his or her orientation.

Information window 932 may include additional options and information associated with the selected program. Additional options may allow the user to, for example, add the program to a favorites list, schedule a recording of the program, request additional information relating to the program, order the program, or perform any other suitable action. The additional information relating to the selected program may include, for example, a detailed description of the program and/or channel, a rating of the selected program, an indication of the progress of the selected program (e.g., a progress bar), and caption information for the program. The progress of the selected program may be displayed as a progress bar that provides a visual indication of the amount of time that has elapsed from the start of the selected program.

In some embodiments, the interactive television program guide application may provide the user with advanced visual features and settings suitable for different types of televisions or consumer electronics.

For example, the interactive television program guide application may provide the user with an interactive program guide screen having graphics of various bit depths (e.g., 8-bit, 16-bit, 32-bit, or any other suitable bit depth). In some embodiments, the interactive television program guide application may allow the user to select the bit depth of the graphics displayed in the interactive program guide screen. In some embodiments, the interactive television program guide application may automatically display graphics at a bit depth suitable for the display equipment or user equipment. For example, the interactive television program guide application may detect the hardware configuration of the user equipment. In response to determining that the user has a high definition television, the interactive television program guide application may automatically select the appropriate bit depth.

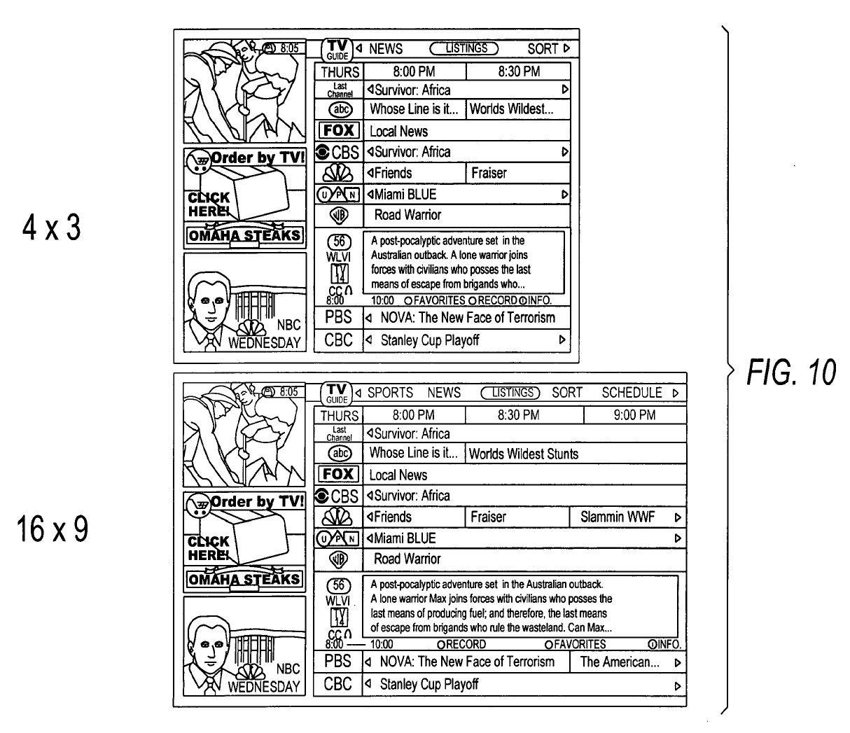

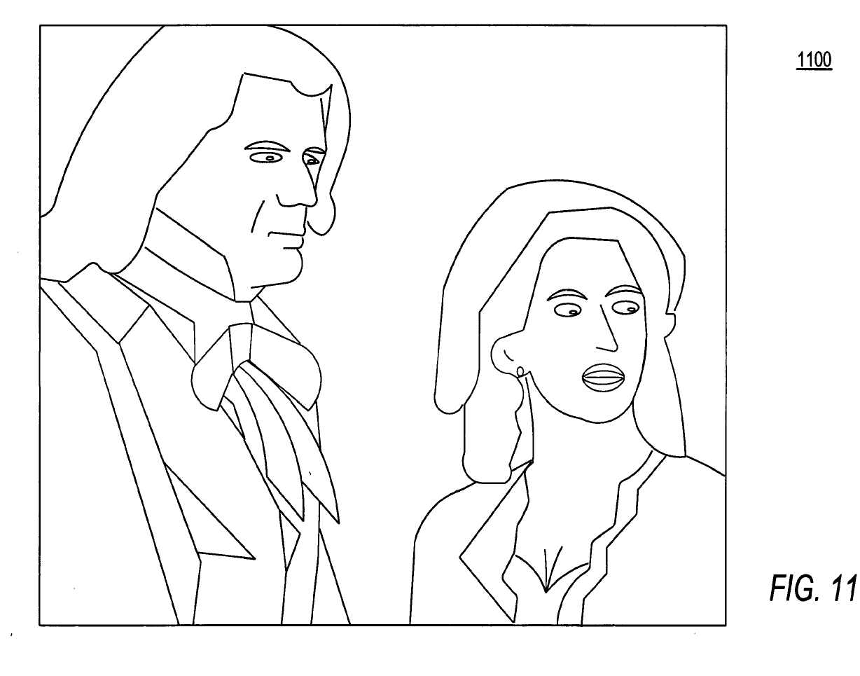

In some embodiments, the interactive television program guide application may also allow the user to select from one or more formats or aspect ratios in which to display the interactive television program guide screens. For example, in response to the user selecting the “Setup” service tab 828 from service navigation bar 804 (FIG. 8), the interactive television program guide application may provide the user with a setup screen (not shown). Setup screen may allow the user to set the aspect ratio. As shown in FIG. 10, the interactive television program guide application may be displayed in 4:3 format or 16:9 format (i.e., wide-screen format). 16:9 format or wide-screen format may allow additional information to be displayed on the interactive program guide screens (e.g., additional time slots, service labels, etc.). In some embodiments, the interactive television program guide application may automatically display the interactive program guide screens in a particular format based at least in part on the display equipment or the user equipment. It should be noted that automatically displaying interactive program guide screens in a particular format may include determining the hardware configuration of the user equipment. For example, if the interactive television program guide application detects that the user equipment supports wide-screen display, the interactive television program guide application may automatically provide displays in wide-screen format.

In some embodiments, the interactive television program guide application may provide the user with graphics to enhance the program listings. For example, the interactive television program guide application may provide the user with drop-shadowed text to display the program listings. In another example, the interactive television program guide application may display descriptions of programs using anti-aliased fonts. In some embodiments, the interactive television program guide application may provide the user with a scrolling graphical enhancement for displaying a consecutive page of program listings. For example, in response to the user requesting to view a consecutive page of program listings, the interactive television program guide application may display a series of screens. The initial screen may show the current page of program listings and each successive screen may show a page of program listings that is shifted up by one listing from the previous screen. The final screen in the series of screens may show the consecutive page of program listings.

FIGS. 11-16 show illustrative display screens for displaying programs that may be provided to the user in accordance with various embodiments of the present invention. In response to the user selecting to view a program by, for example, using remote control 72, the interactive television program guide application may provide the user with an illustrative program display screen 1100 as shown in FIG. 11.

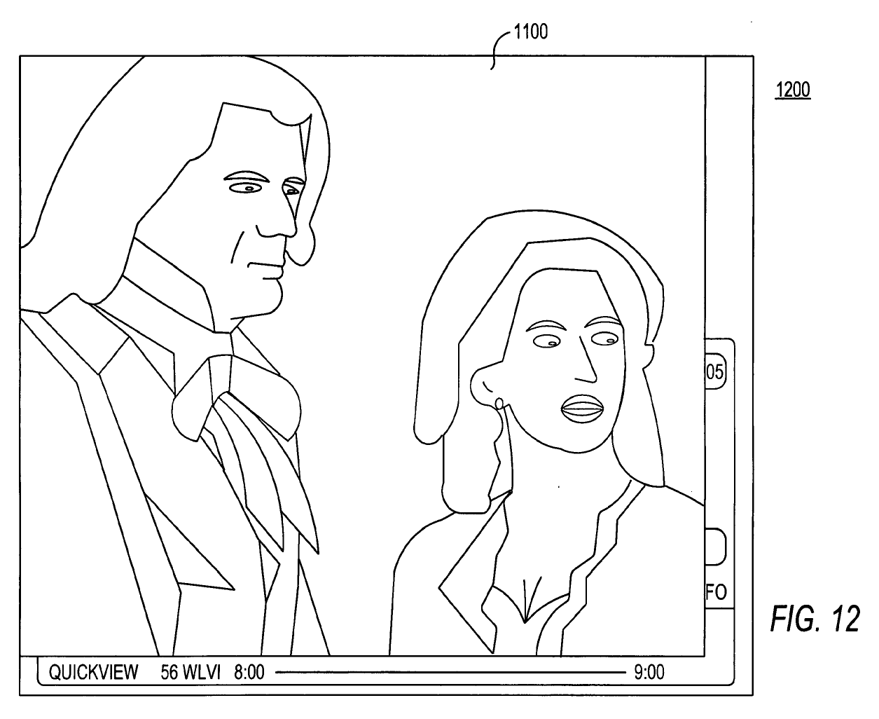

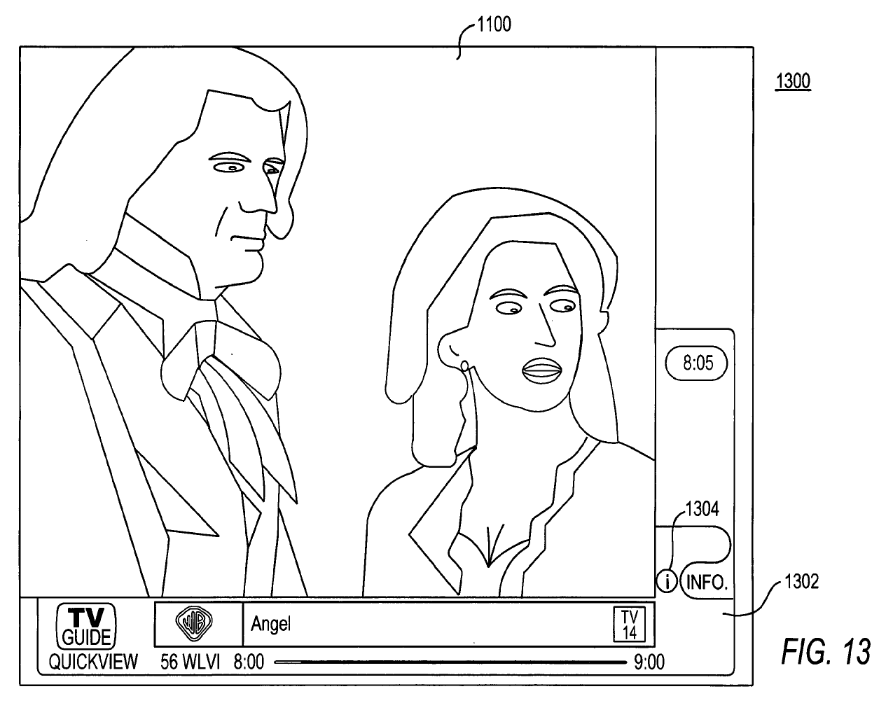

In response to receiving a request from the user to view program information for the currently viewed program, the interactive television program guide application may provide the user with a series of display screens. For example, in each successive screen, video window 1100 may become smaller (FIG. 12) until video window 1100 is sufficiently small enough to be displayed along with an information bar 1302 (FIG. 13). In some embodiments, the sequence of display screens may appear as an animation. In some embodiments, instead of an animation, intermediate screens in which information bar 1302 is obscured by video window 1100, such as in display screen 1200 (FIG. 12), may be omitted.

In the example of FIG. 13, information bar 1302 may include promotional information, program information (e.g., channel and title information for the selected program, an indication of the progress of the displayed program relative to the current time and the scheduled start and end times of the selected program (e.g., a progress bar), a rating of the selected program, etc.), the current time, or any other suitable information. Information bar 1302 may also include options that allow the user to, for example, request additional information (e.g., by pressing an “Info” button), record the program, or perform any other suitable action. In response to the user selecting an “Info” button 1304, the interactive television program guide application may provide the user with additional information associated with the selected program. For example, the additional information provided to the user may be similar to the information displayed in information window 932 (FIG. 9).

In some embodiments, the interactive television program guide application may allow the user to view program information while watching a television program. Two illustrative displays for displaying program information with television programs are, for example, flip and browse displays. Flip displays may be displayed whenever the user changes television channels or otherwise indicates a desire to view a flip display (e.g., by pressing a suitable button on the remote control). Flip displays may provide the user with information on the television program that is being carried on the current channel. Flip displays may be displayed for a predefined period of time, or for a displayed configurable period of time, if desired. Flip displays may instantaneously disappear, may slide downward off the screen, or may be removed from the screen using any other suitable approach.

Flip displays may include information associated with the current program, such as the channel on which the selected program is being broadcast, the title of the selected program, an indication of the progress of the displayed program relative to the current time and the scheduled start and end times of the selected program (e.g., a progress bar), a rating of the selected program, and any other suitable information.

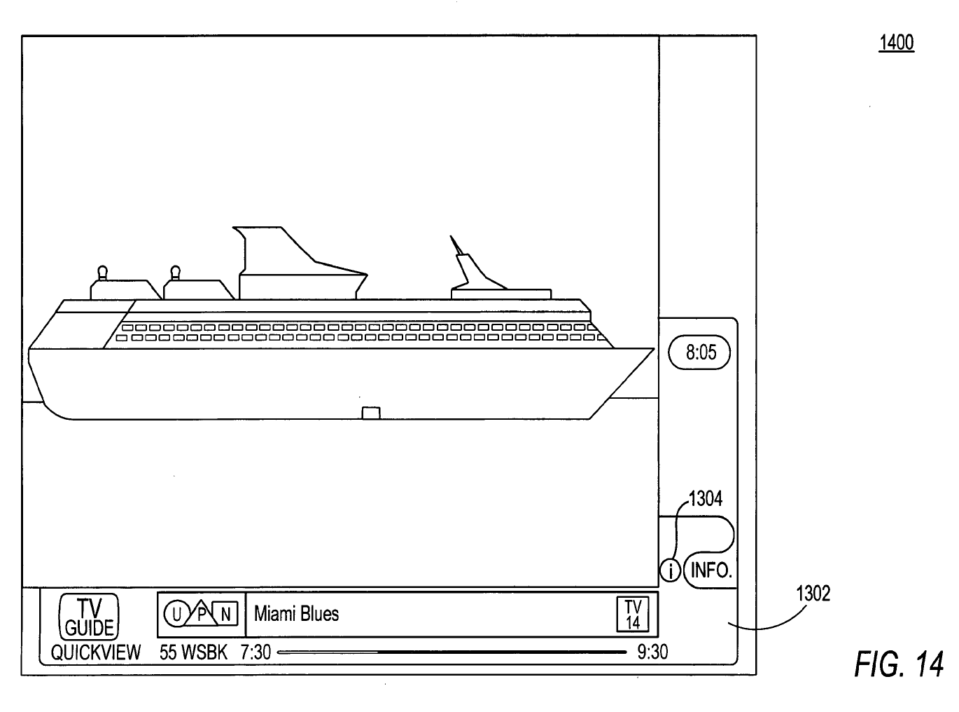

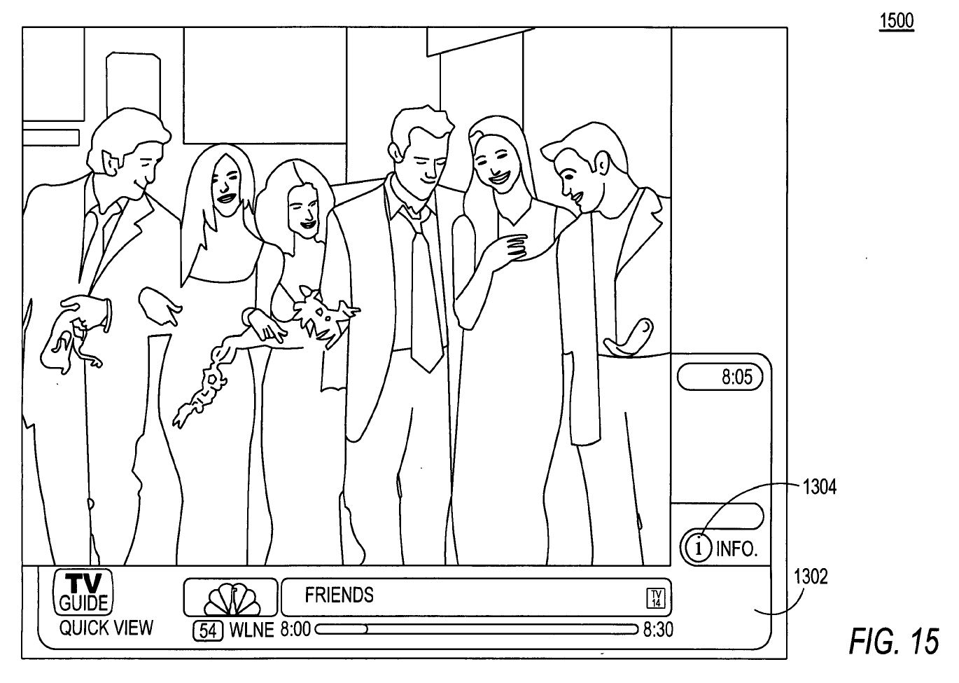

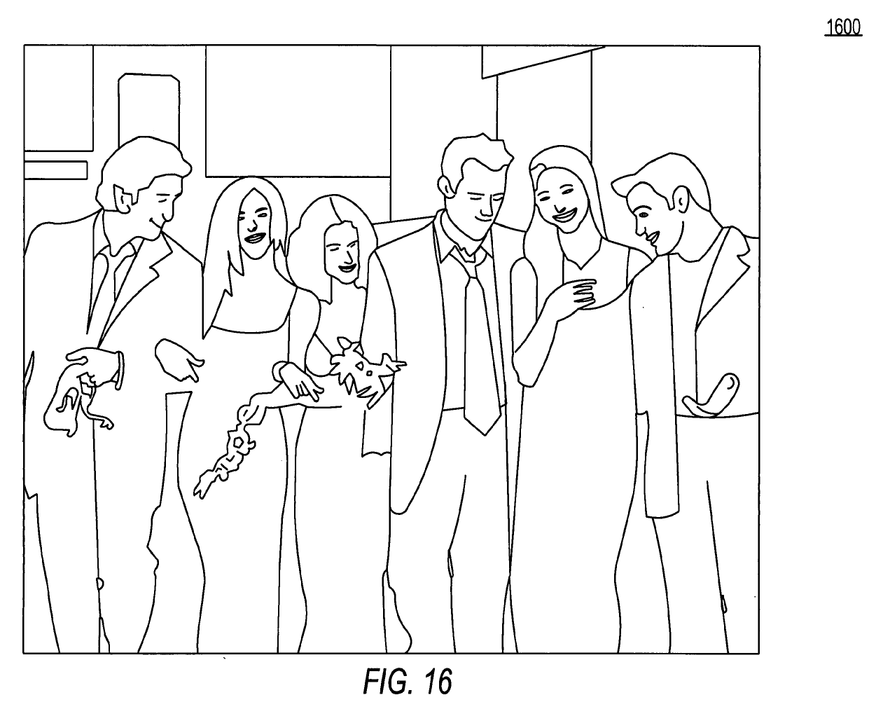

In response to the user changing to another program, the interactive television program guide application may display the newly selected program and update the information displayed in information bar 1302 to correspond to the newly selected program. For example, as shown in FIG. 14, the user has selected to change the program from “Angel” to “Miami Blues.” In response to changing to the program “Miami Blues,” the interactive television program guide application may update information bar 1302 to reflect the change in program. Similarly, the user has selected to change the program to “Friends” in FIG. 15. In response, the interactive television program guide application has updated information bar 1302 to provide program information relating to “Friends.”

Unlike flip displays, browse displays may allow a user to continue watching a program on a particular channel while browsing information for programs that are playing on other channels and at other times. The user may indicate a desire to browse through program listings for other channels and time slots by, for example, pressing an arrow key on the remote control. In some embodiments, the interactive television program guide application may also provide the user with a progress bar in a browse display.

In response to the user closing the flip display shown in FIG. 15, the interactive television program guide application may display screen 1600 shown in FIG. 16. As shown in FIG. 16, the interactive television program guide application has resized the video window to encompass the entire screen.

In some embodiments, the interactive television program guide application may also provide real-time services, such as, for example, sports scores, news, and weather information to users. For example, the interactive television program guide application may display listings of real-time sports scores. The interactive television program guide application may allow the user to obtain additional information for each listed score. In some embodiments, the interactive television program guide application may provide the user with an alert for updates of real-time sports information while, for example, the user watches television.

It should be noted that the data distribution technique that is used to distribute real-time data to user equipment 18 (FIG. 2) on either of paths 26 or 42 (FIG. 2) may depend on the type of information that is being distributed. For example, text and graphics relating to a weather forecast may be distributed over an out-of-band channel using an out-of-band modulator or distributed in the vertical blanking interval lines of an analog video channel. Video information may also be distributed in this way, although large quantities of video information may be more efficiently distributed using one or more digital channels or streams on paths 26 or 42 (FIG. 2). Such digital channels or streams may also be used for distributing text and graphics.

If desired, an interactive television program guide may be implemented using a client-server architecture. In a client-server arrangement, the program guide is partially implemented on a client. The server may be a server, such as server 36 or server 56 (FIG. 2), at television distribution facility 14 (FIG. 2). The client may be user television equipment (e.g., a set-top box). Program guide data and real-time data that are distributed to client-server program guide at television distribution facility 14 may be stored in a database at television distribution facility 14 (FIG. 2). For clarity, the present invention is sometimes described primarily in the context of program guides that are implemented on user television equipment, rather than in the context of program guides that are implemented partially on a server and partially on user television equipment.

Real-time data may be delivered using several approaches. In one suitable approach, real-time data may be delivered immediately to the interactive television program guide application. For example, when a user is watching a hockey game, the interactive television program guide application may display real-time information relating to the hockey game as it becomes available. In another example, when a tuner tunes to a program, real-time information relating to the program may automatically be retrieved by the interactive television program guide application. The real-time information may be retrieved from a database. In another example, when the user selects a listing having real-time information, one of the tuners that is tuned to the program may provide the program to the user (e.g., a video clip).

In another suitable approach, real-time data may be delivered at predetermined intervals. A database of real-time data (e.g., a database at data source 30 (FIG. 2), a database at a television distribution facility, storage on a digital video recorder, etc.) may be stored and maintained. The database may deliver real-time data to the interactive television program guide application at intervals determined by, for example, television distribution facility 14 (FIG. 2). For example, real-time data regarding news headlines may be delivered to the interactive television program guide application once every hour. Although real-time data may be constantly available in the database, in order to reduce excessive bandwidth usage, the interactive television program guide application may only request real-time data at specific times. Real-time video information may also be stored in the database. The database of real-time video may also be constantly updated with new video clips. For example, when the user selects a listing having real-time information, the interactive television program guide application may retrieve a related video clip from the database to display to the user.

In some embodiments, real-time video information may be delivered by locally recording the video clip from the output of a tuner (e.g., using a digital video recorder) and displaying the video clip to the user at a later time, such as, for example, when the user selects a corresponding listing.

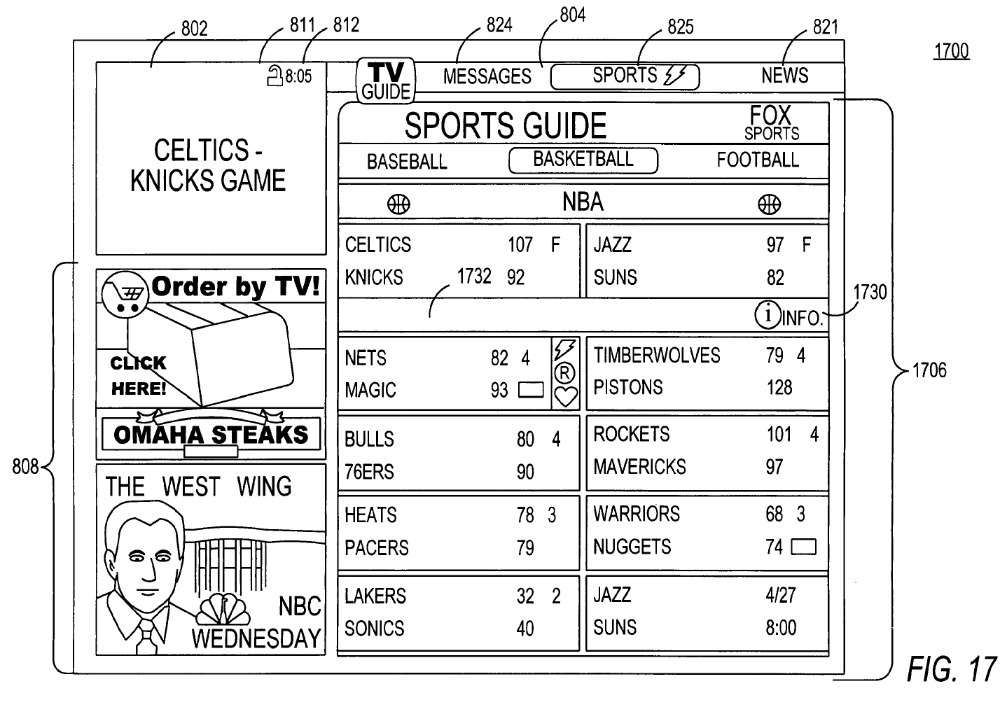

FIGS. 17-25 show illustrative sports scores and sports-related display screens that may be provided by the interactive television program guide application in accordance with various embodiments of the present invention.

FIG. 17 shows an illustrative sports scores display that provides the user with real-time sports information in accordance with various embodiments of the present invention. Sport scores display 1700 may be displayed to the user, for example, in response to the user selecting “Sports” service tab 825 from navigation bar 804. Listings area 1706 may include a listing of sports scores. In the example of FIG. 17, listings area 1706 includes a listing of basketball games, where some of the events are currently in progress and others have ended. Each listing may include information such as, for example, the real-time score of the game and the status of the game (e.g., an F to indicate that it is the final score, a 4 to indicate that the game is currently in the fourth quarter, etc.).

For games that are in progress, the interactive television program guide application may update the information, such as the current score, player statistics, and other information related to the game, in real-time. For example, every time one of the teams (e.g., the Celtics or the Knicks) scores a point, the interactive television program guide application may update the currently displayed listing to reflect the new score.

In addition, some listings for sports games may contain icons, such as, a television icon, a flash icon (shown as a bolt of lightning), a reminder icon (shown as an “R”), a favorite icon (shown as a heart), or any other suitable icons.

The television icon may inform the user that the game is currently being broadcast on television. For example, if a game is broadcast on a channel available to the user, the interactive television program guide application may display the television icon in the listing for the game. The television icon may be selectable by the user. In response to the user selecting the television icon, the interactive television program guide application may provide the user with the currently broadcasted game. For example, the interactive television program guide application may automatically tune the user equipment to the channel that is broadcasting the selected game.

The flash icon may inform the user that the user has set an alert for one or more of the teams corresponding to the selected listing. The interactive television program guide application may provide the user with an alert for real-time information relating to a team for which the user has set a flash alert.

The reminder icon may indicate that the user has set a reminder for the game. In response to the user setting a reminder for a game, the interactive television program guide application may provide the user with a reminder before the scheduled start time of the corresponding game.

The favorite icon may indicate that the user has set the game as a favorite. In response to the user setting the game as a favorite, the interactive television program guide application may add the game to the user's favorites list. In some embodiments, the interactive television program guide application, in response to the user invoking a favorites view of the guide (e.g., a program guide view containing user favorites information, including the user's favorites list), may prominently display those favorite sporting events that are about to start.

As shown in FIG. 17, the interactive television program guide application may provide the user with a highlight region in listings area 1706 for selecting one of the listed games. In some embodiments, a video window 802 may display the output of a tuner tuned to the channel currently broadcasting the game in response to highlighting a program listing. In some embodiments, the interactive television program guide application may retrieve a video clip related to the game from a database. Alternatively, video window 802 may include a video of a general sports program providing highlights of various games (e.g., ESPN Sportscenter), when, for example, a video of the highlighted game is unavailable. For example, when a video of the program corresponding to the highlighted listing is unavailable (e.g., not stored in a database), the interactive television program guide application may retrieve an alternate video clip from the database. In some embodiments, the alternate video clip is related to the highlighted listing.

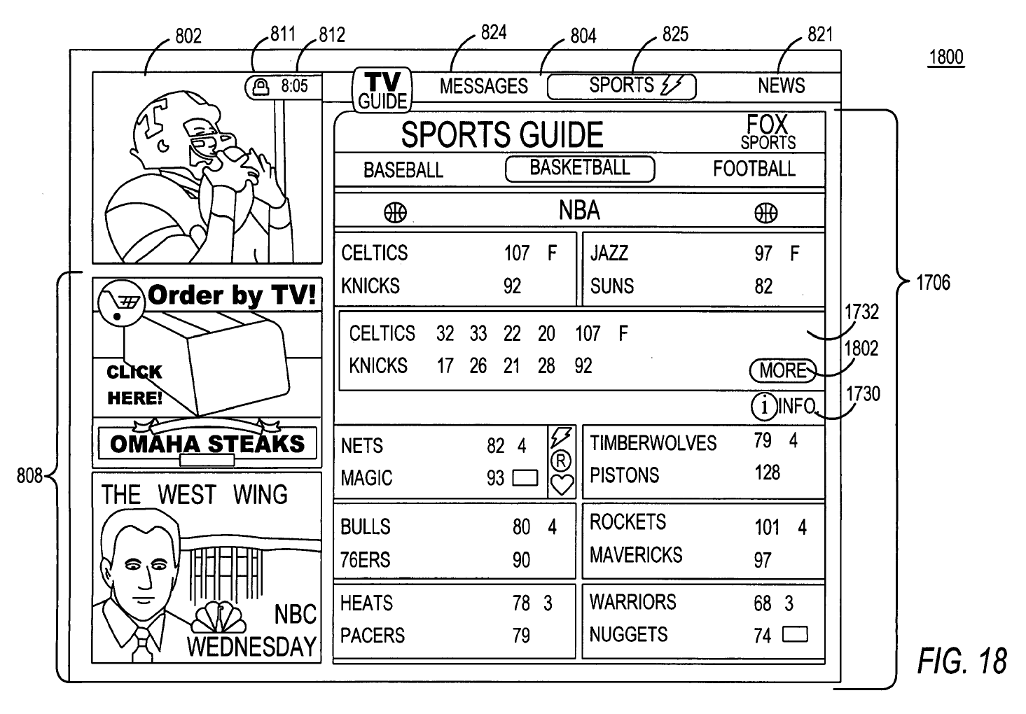

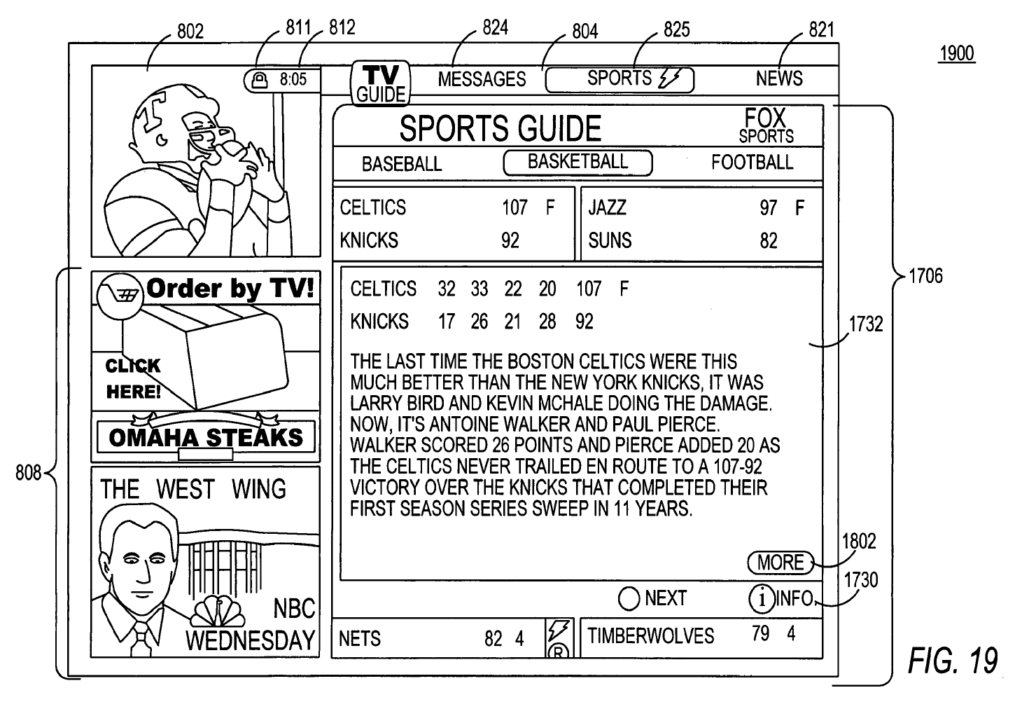

In response to receiving a request from the user to receive information on the currently highlighted listing (e.g., by selecting “Info” button 1730), the interactive television program guide application may provide the user with information window 1732. Information window 1732 may include, additional information, such as, for example, a breakdown of the points scored each quarter by each team (as shown in FIG. 18), statistics related to the game (e.g., the highest point scorer, the leading rebounder, etc.), or any other suitable information relating to the selected game. As shown in FIG. 18, the additional information relating to the selected game may be provided in an information window 1732 positioned adjacent to the selected game listing.

In some embodiments, the interactive television program guide application may also allow the user to request further information for the highlighted game. As shown in FIGS. 18 and 19, in response to receiving a request from the user for further information (e.g., by selecting “Info” button 1730 or by selecting “more” button 1802), the interactive television program guide application may provide the user with, for example, an analysis of the game, a summary of the game, a re-cap of the game, a play-by-play listing, a breakdown of the scores, commentary on the given game, the player lineup for the game, team news, etc. In response to the user selecting “Info” button 1730 another time, the additional information for the selected game may be removed from listings area 1706.

In some embodiments, the interactive television program guide application may provide the information window, such as information window 1732, until, for example, the user requests that the information window be removed or after a predetermined period of inactivity.

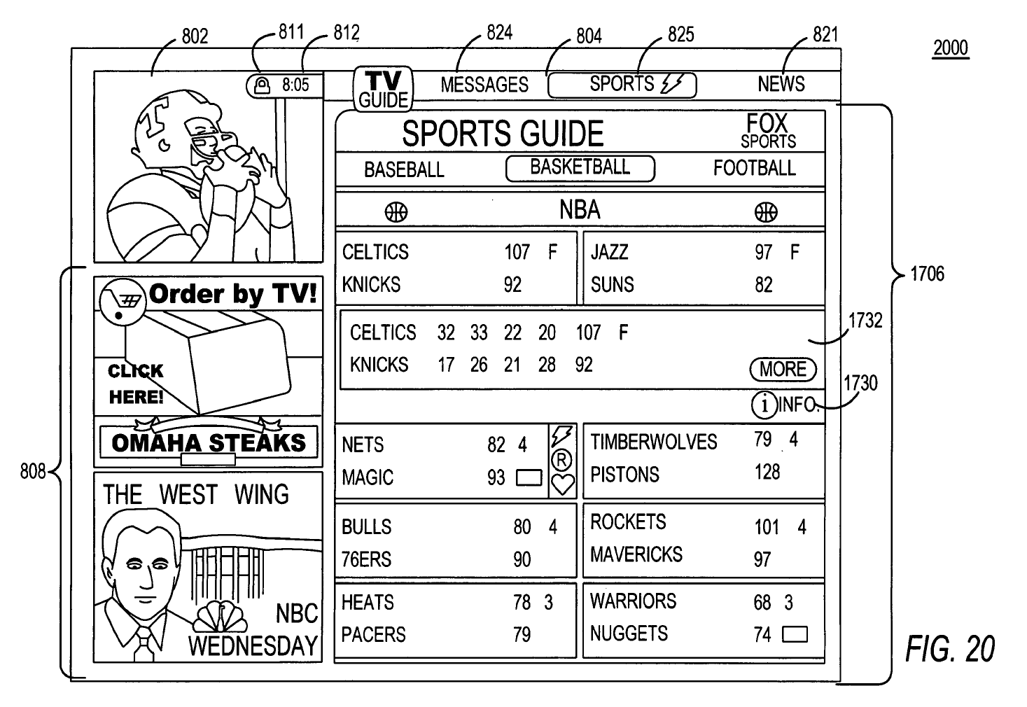

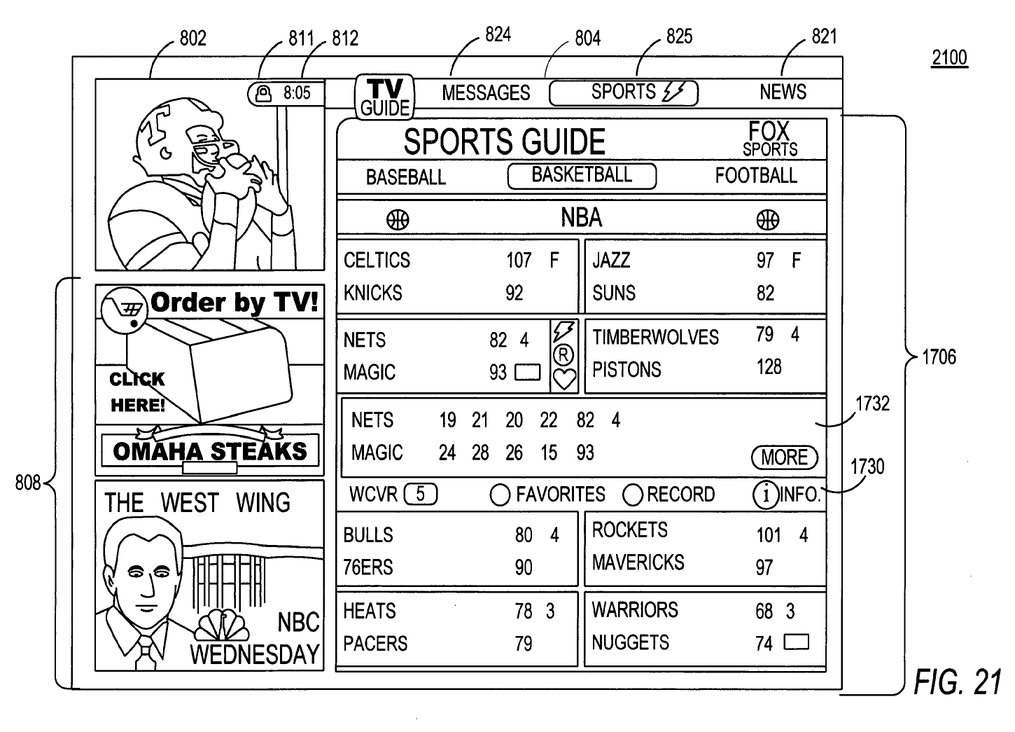

In response to the user navigating from a first listing to a second listing, where an information window is displayed for the first listing, the information window is repositioned adjacent to the second listing and includes information for the game corresponding to the second listing. For example, as shown in FIG. 20, the user has currently highlighted the “Celtics vs. Knicks” basketball game. The interactive television program guide application has also provided the user with an information window 1732 that is within the currently highlighted listing. In response to the user highlighting another listing (e.g., by using the arrow keys on the remote control), the interactive television program guide application may provide the user with an information window 1732 for the newly highlighted listing. For example, in FIG. 21, the user has highlighted the “Nets vs. Magic” basketball game. In response to highlighting that game, the interactive television program guide application provides the user with information window 1732 within the newly highlighted listing.

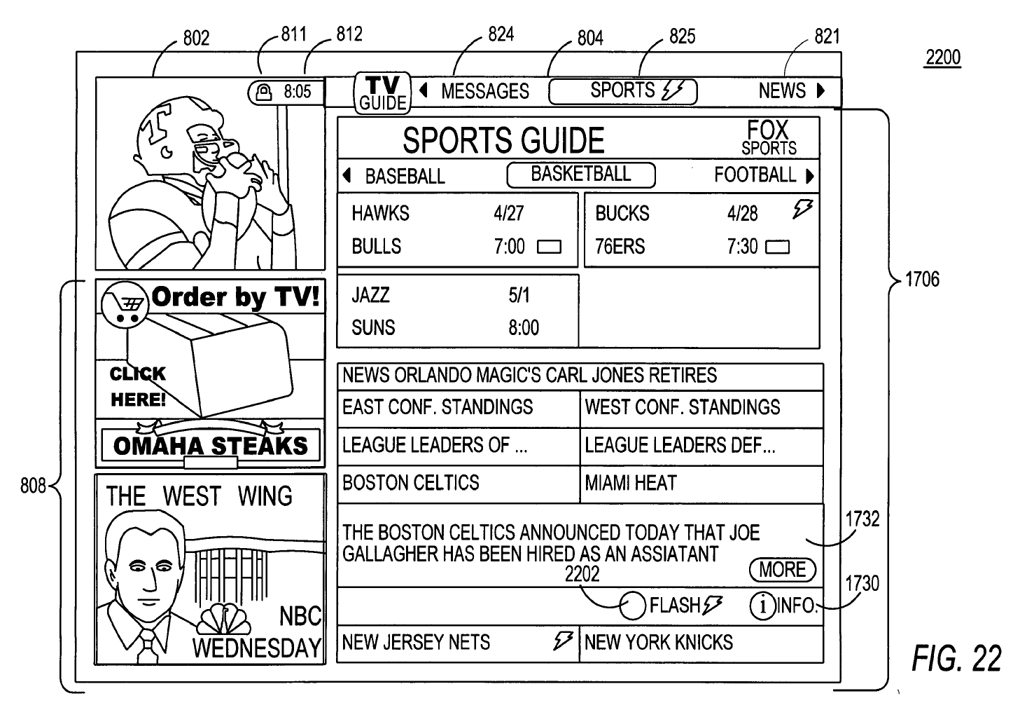

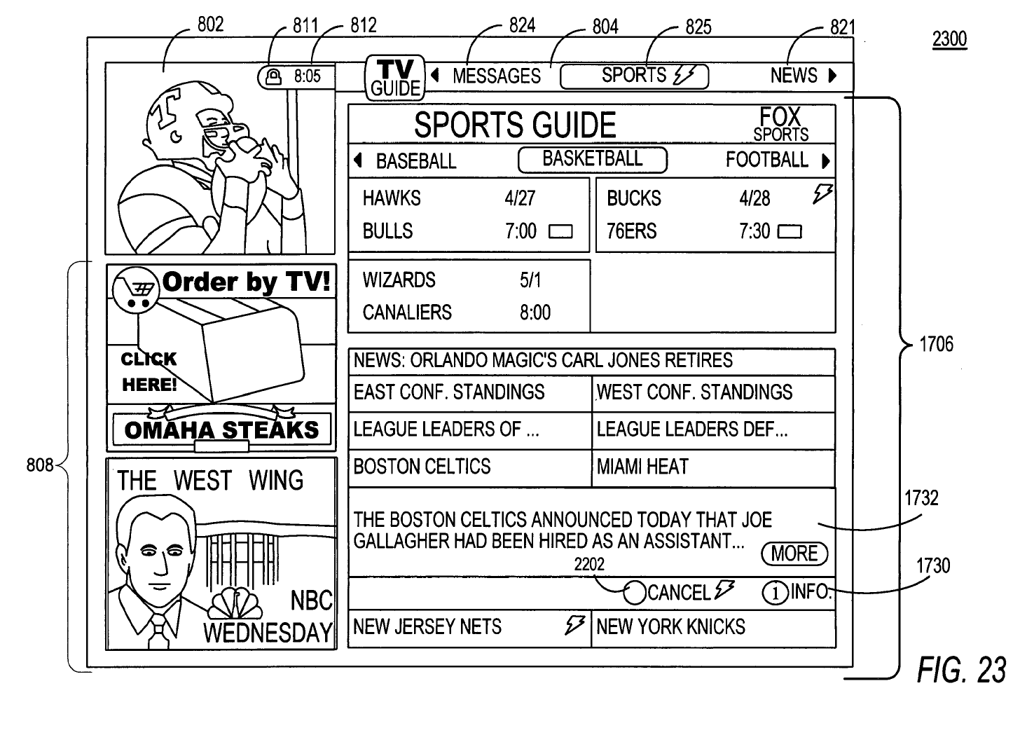

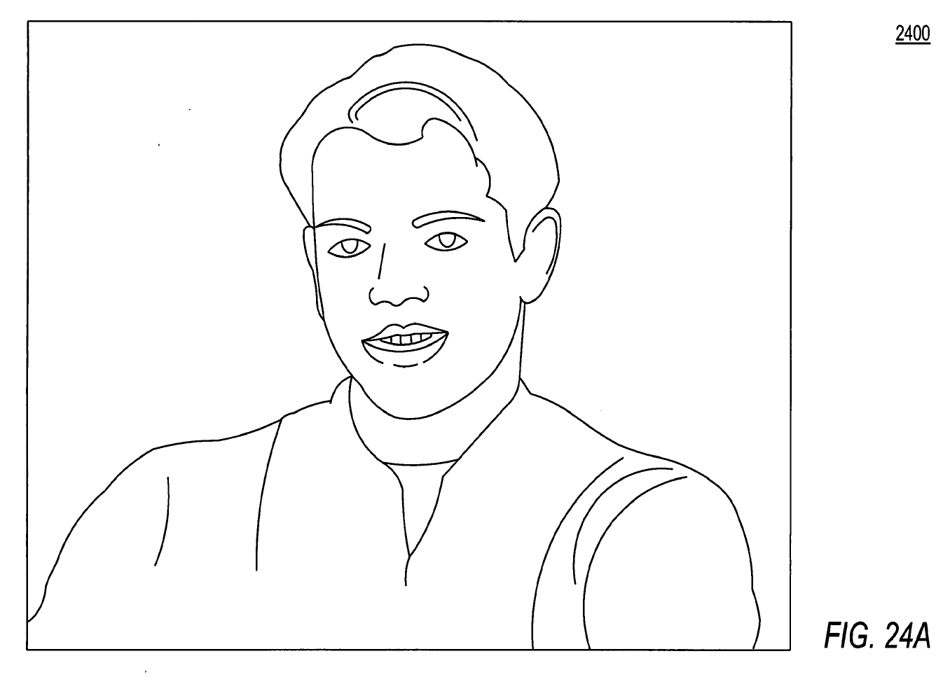

In some embodiments, in addition to game listings, the interactive television program guide application may also provide other listings related to sports, such as, sports news and team information in the listings. As shown in FIGS. 22 and 23, the interactive television program guide application may provide the user with listings that includes sports scores, sports news, and team information. In response to the user selecting one of the listings (e.g., a listing identifying a team name), the interactive television program guide application may provide the user with news related to the selected listing. For example, as shown in FIG. 22, in response to the user selecting the “Boston Celtics,” the interactive television program guide application may provide the user with news relating to the “Boston Celtics.”

In some embodiments, the interactive television program guide application may provide real-time content related to the selected listing. For example, the interactive television program guide application may allow the user to set an alert for real-time content associated with the selected listing. The alert may inform the user of all forms of real-time content relating to the selected listing (e.g., updated score, breaking news, highlights, television program discussing a topic related to the selected listings, etc.). The interactive television program guide application may, for example, display an alert while the user is watching a television program. Such an alert may inform the user of the availability of real-time content. For example, the alert may inform the user of an occurrence in a real-time event, such as, for example, a change in the score of a game that the user has indicated an interest in. As shown in FIG. 22, the interactive television program guide application provides the user with an opportunity to set an alert for the “Boston Celtics” by selecting flash button 2202. The interactive television program guide application may also allow the user to cancel the alert by selecting flash button 2202 a second time. However, any other suitable approach for setting an alert may also be used. For example, the interactive television program guide application may provide the user with a pre-configured remote control key for setting alerts for real-time content.

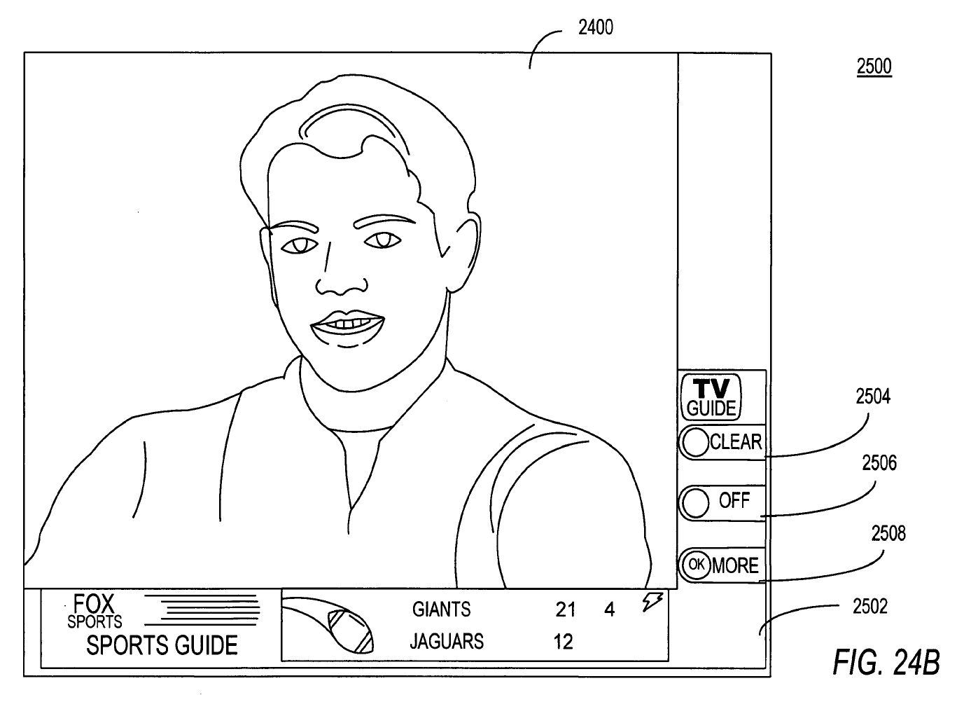

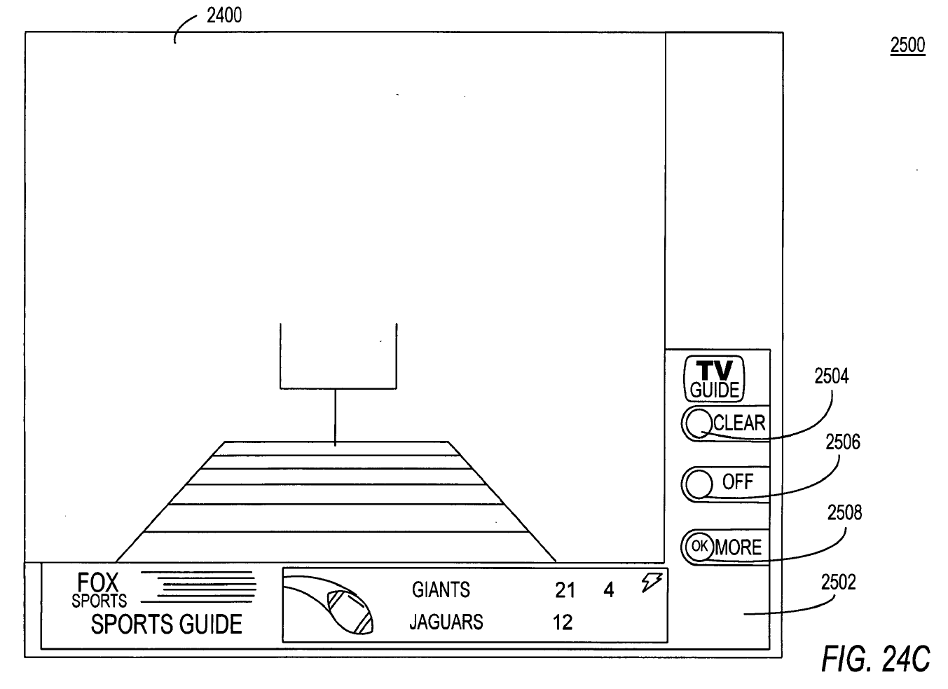

FIGS. 24A-24C are illustrative screens for displaying an alert to the user while the user is viewing a program. As shown in FIG. 24A, the user is watching a program. In response to the interactive television program guide application receiving real-time content for which the user has set an alert, the interactive television program guide application displays an alert on display screen 2500 informing the user that the score in the Giants-Jaguars game has changed to 21-12 (as shown in FIG. 24B). An alert 2502 may be displayed in response to the user setting an alert for the Giants, the Jaguars, football games, or any suitable combination thereof. The real-time content (e.g., the updated score) may be displayed in response to the occurrence of a real-time event, such as a touchdown by one of the teams. Alternatively, alert 2502 may be displayed as an overlay over the video for the current program.

In some embodiments, in addition to alert 2502 that real-time content is available, the interactive television program guide application may also provide the user with information, such as, for example, promotional information, score information, and status information (e.g. the current period of play).

Alert 2502 may also provide the user with options, such as, for example, a clear alert button 2504, a turn off alert button 2506, and a more information button 2508.

In response to the user selecting clear alert button 2504, the interactive television program guide application may remove alert 2502 from display screen 2500. In some embodiments, the interactive television program guide application may automatically remove alert 2502 from screen 2500 after a predetermined amount of time (e.g., 30 seconds) has elapsed.

In response to the user selecting turn off alert button 2506, the interactive television program guide application may disable the alert. For example, the interactive television program guide application may not display an alert relating to the Giants-Jaguars game. In another example, the interactive television program guide application may not display any alerts relating to real-time content for a predetermined time (e.g., the rest of the day). In some embodiments, the interactive television program guide application may provide the user with an opportunity to cancel future alerts that relate to the current alert. For example, if an alert had been set for the Giants, the interactive television program guide application may refrain from displaying alerts in the future that relate to the Giants.

In response to the user selecting more information button 2508, the interactive television program guide application may display additional information relating to the alert. For example, the interactive television program guide application may provide the user with a play-by-play description, game statistics, or any other suitable information relating to the alert.

In some embodiments, alert 2502 may be selectable by the user. In response to the user selecting alert 2502, the interactive television program guide application may provide the user with the program corresponding to alert 2502. For example, as shown in FIG. 24B, the interactive television program guide application provides the user with alert 2502 for the “Giants vs. Jaguars” football game. In response to the user selecting alert 2502, the interactive television program guide application may provide the user with the “Giants vs. Jaguars” football game (as shown in FIG. 24C). For example, the interactive television program guide application may automatically tune the user equipment to the channel that is currently broadcasting the “Giants vs. Jaguars” football game.

In some embodiments, the interactive television program guide application may allow the user to configure the alerts for receiving real-time content. The interactive television program guide application may provide the user with a display screen, such as a set-up screen, for selecting options relating to each selected real-time content. For example, if the user wants to receive alerts relating to the “Boston Celtics,” the interactive television program guide application may provide the user with options for the alerts. Options may include, for example, types of real-time content to receive (e.g., highlights, video clips of buzzer beaters, the score when the lead changes, etc.), the amount of real-time content (e.g., all real-time content, only real-time content that the provider has set as high priority, etc.), or any other suitable option.

In some embodiments, the interactive television program guide application may allow the user to prioritize real-time content. By prioritizing real-time content, the interactive television program guide application may allow the user to limit the frequency of alerts displayed to the user. For example, the user may not want to receive an alert every time a team scores in a basketball game. Instead, the interactive television program guide application may allow the user to receive alerts for real-time content that the provider has set as high priority. For example, the interactive television program guide application may provide an alert when a selected team has tied the score for the Super Bowl, a selected team has scored a run to tie the game, etc. In some embodiments, the interactive television program guide application may provide the user with a list of real-time content for which the user may receive alerts. The user may prioritize the list to show real-time content that the user is more interested in.

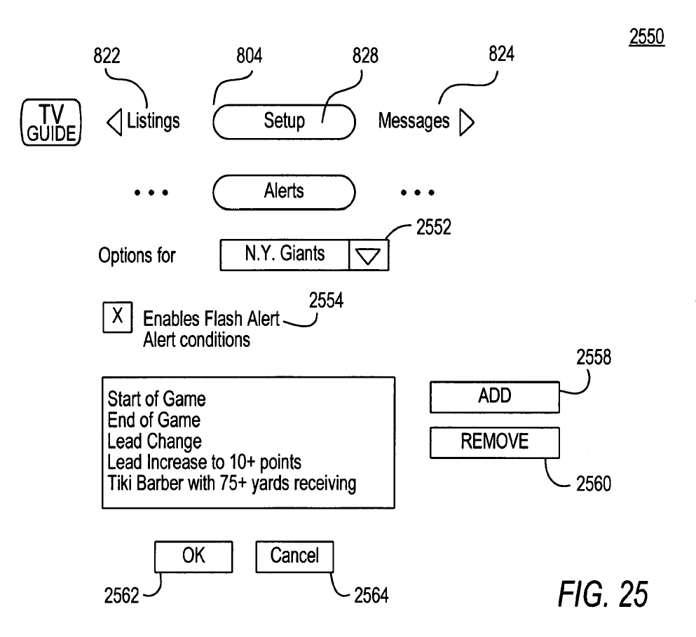

FIG. 25 shows an illustrative alert setup screen 2550 that the interactive television program guide application may provide to the user in accordance with various embodiments of the present invention. In response to the user selecting “Setup” tab 828 from service navigation bar 804, the interactive television program guide application may provide the user with alert setup screen 2550. In FIG. 25, the interactive television program guide application may allow the user to configure alerts for preferred real-time content that has been selected by the user (e.g., by selecting the flash icon for particular listings). Screen 2550 may include a drop-down menu 2552 or any other suitable user interface construct (e.g., a list, a radio button, etc.) to select preferred real-time content. For example, the user has selected the “New York Giants” from drop-down menu 2552. In response to the user selecting “New York Giants,” the interactive television program guide application may display the current settings for receiving alerts for real-time content relating to the “New York Giants.” For example, in response to the user selecting check box 2554, the interactive television program guide application may display alert conditions window 2556 that includes conditions under which an alert may be displayed. These conditions may include, for example, start of game (the user is alerted when the game begins), end of game (the user is alerted to the ending of the game), lead change (the user is alerted when the lead changes), lead increase to 10+ points (the user is alerted when one team leads the other team by 10 or more points), a goal for a particular player (the user is alerted when the player achieves a set goal), or any other suitable condition.

The interactive television program guide application may allow the user to modify the conditions under which an alert is displayed by using add button 2558 and remove button 2560. In response to the user selecting add button 2558, the interactive television program guide application may provide the user with a list containing all conditions that the user may set for the current alert. In response to the user selecting one of the conditions, the interactive television program guide application may display the selected condition in window 2556. In response to the user highlighting a condition in window 2556 and selecting remove button 2560, the interactive television program guide application may remove the condition.

In some embodiments, the interactive television program guide application may provide real-time information relating to news headlines. A listings region similar to the sports listings region may be provided that includes a plurality of news listings where each listing corresponds to a news headline. Information, such as the news story, corresponding to a selected listing may also be displayed in the listings region. The interactive television program guide application may also alert the user to developing news or news updates while the user is watching a program.

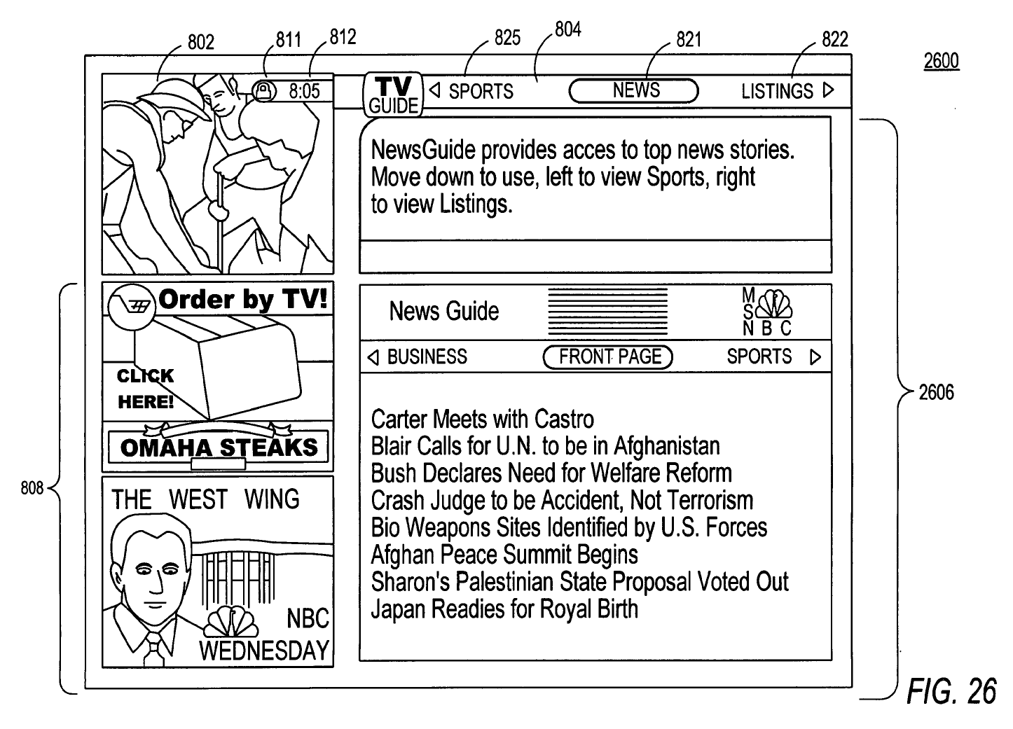

FIGS. 26-32 show illustrative real-time news screens that may be provided by the interactive television program guide application in accordance with various embodiments of the present invention.

FIG. 26 shows an illustrative news screen 2600 that the interactive television program guide application may provide to the user in response to, for example, the user selecting “News” service tab 821 from service navigation bar 804. As shown in FIG. 26, the interactive television program guide application may provide the user with listings of news headlines in listings area 2606. The listings of news headlines may be sorted by time, category, or other suitable criteria. For example, as shown in FIG. 26, each news headline is sorted by a news category, such as business, sports, and front page.

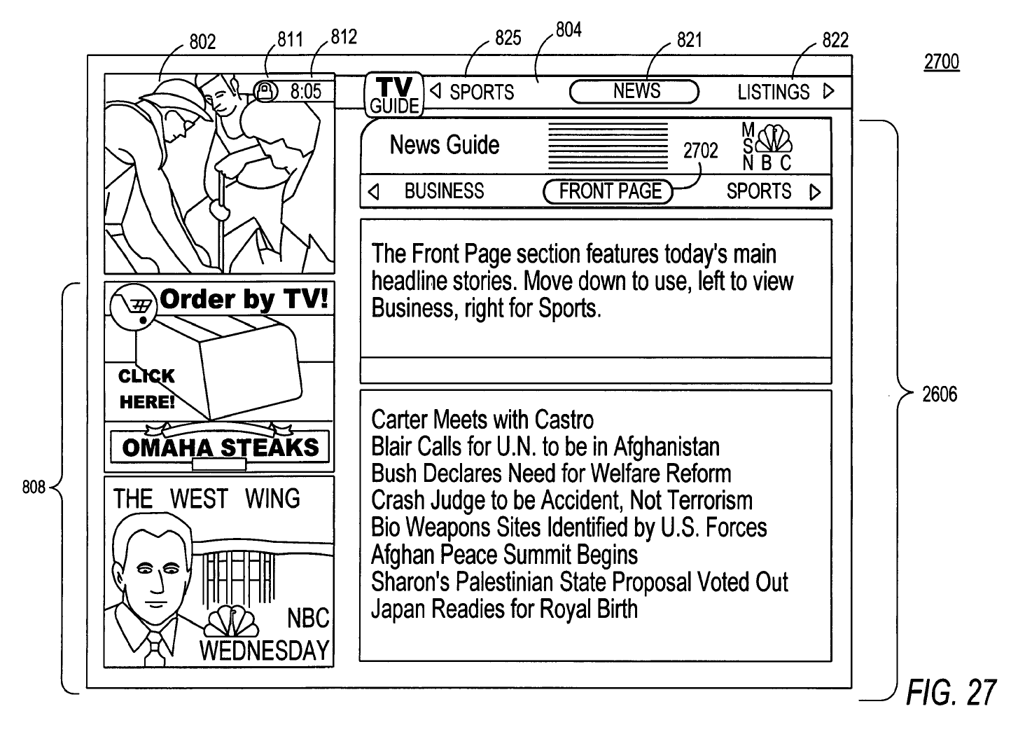

FIG. 27 shows front page headlines in response to the user selecting a “Front Page” tab 2702. In response to the selecting “Front Page” tab 2702, the interactive television program guide application may provide the user with listings. Each listing may be identified by a news headline, such as, for example, “Bush Declares Need for Welfare Reform.” In response to the user highlighting a news listings, the interactive television program guide application may provide the user with a video window 802 that includes a video clip pertaining to the highlighted headline. The video clip may be a pre-recorded video or a real-time video pertaining to the selected headline. The real-time video clip may be obtained by tuning one of the tuners in the user's equipment to a channel broadcasting the video or by retrieving the video clip from a database.

In some embodiments, if a video clip pertaining to the selected headline is unavailable, video window 802 may include a news program. For example, if business headlines are displayed in listings area 2606 and the selected headline does not have a corresponding video, video window 802 may include a business news program (e.g., a CNBC program). In another example, if general headlines are displayed in listings area 2606 and the selected headline does not have a corresponding video, video window 802 may include a general news program, such as, for example, “NBC Nightly News.”

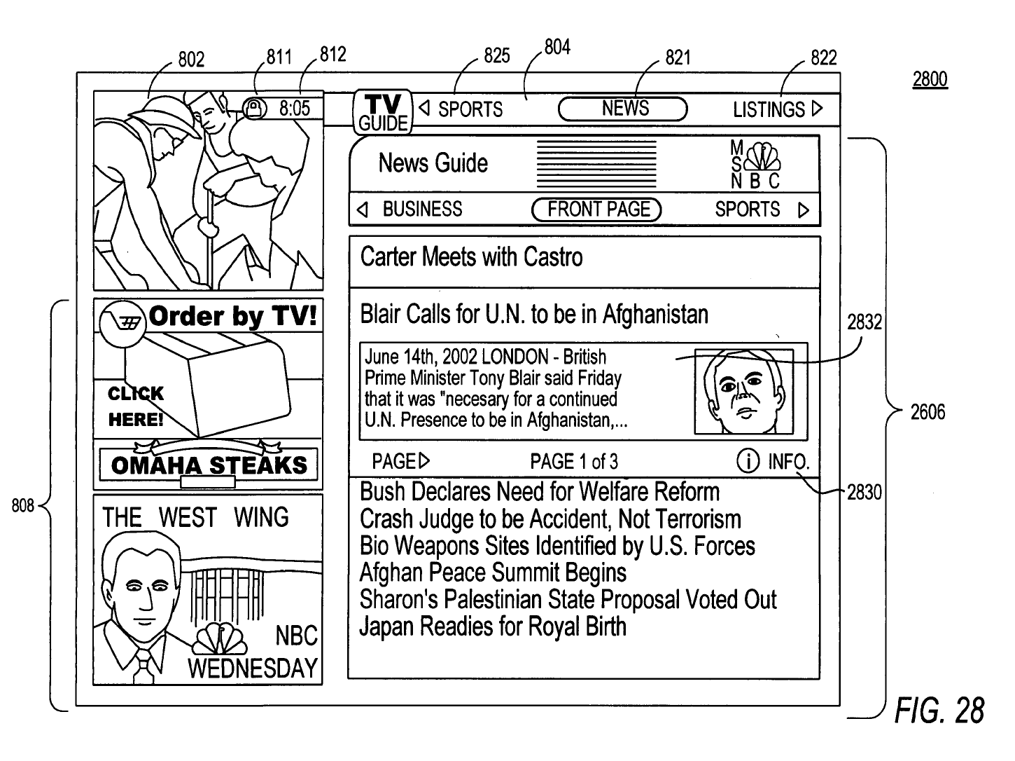

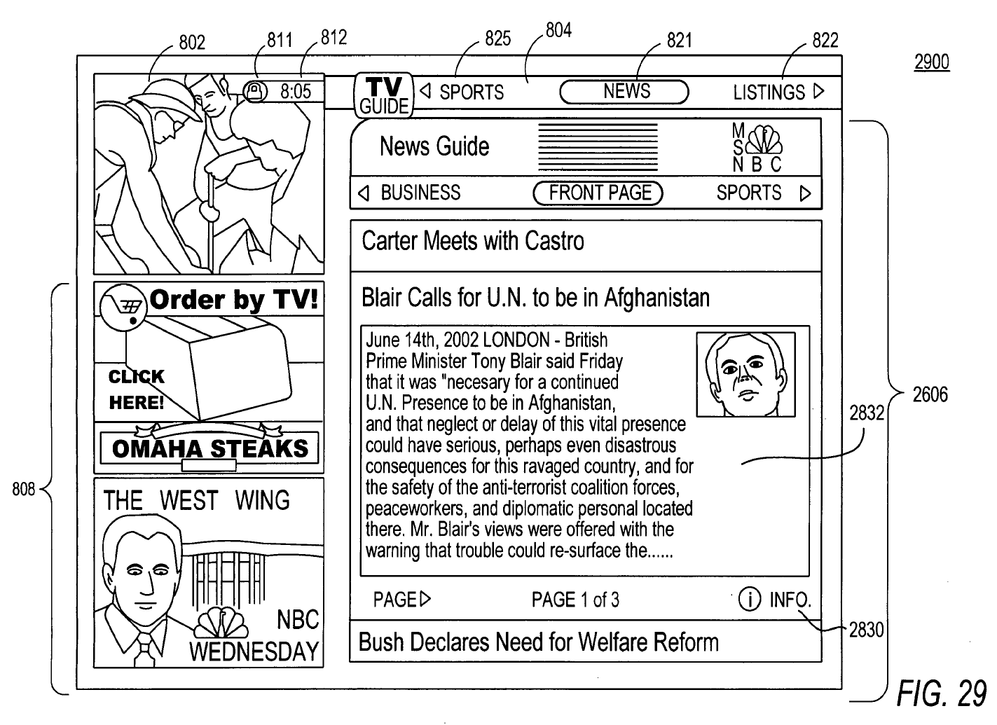

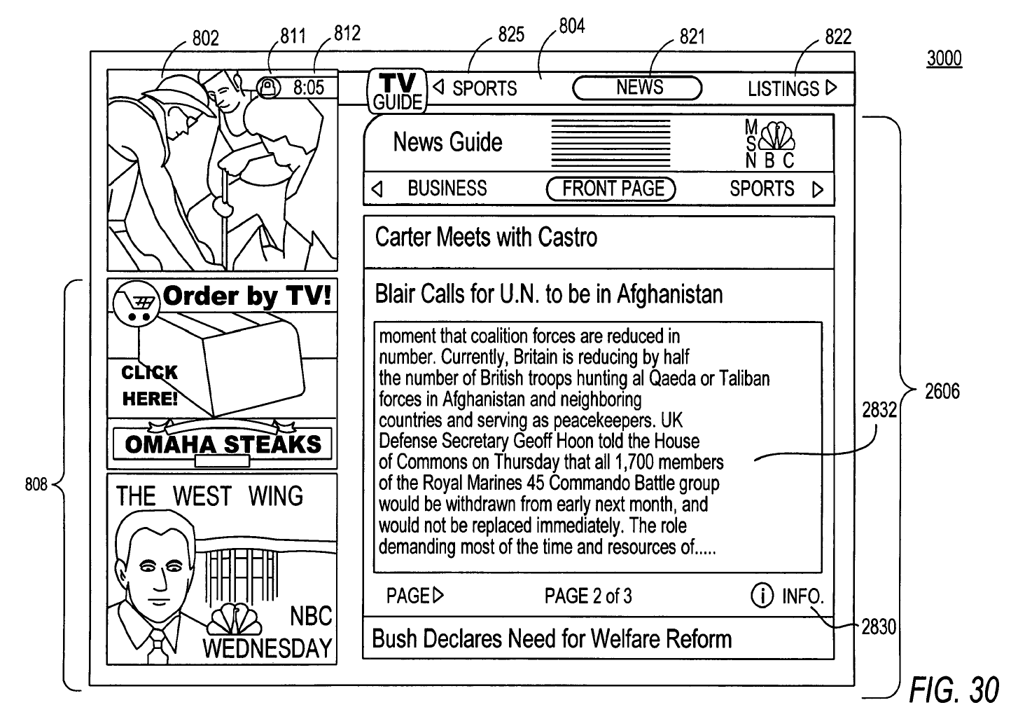

As shown in FIGS. 28-30, the interactive television program guide application may provide the user with additional information pertaining to the selected headline in an information window in accordance with various embodiments of the present invention. In response to the user highlighting a news listing and pressing, for example, an “INFO” button on the remote control, the interactive television program guide application may provide the user with an information window 2932. Similar to information window 932, information window 2932 may be positioned within the highlighted listing. Information window 2932 may provide the user with some or all of the news information corresponding to the highlighted listing. The interactive television program guide application may provide the user with, for example, a scroll bar, push button, drop-down menu, or any other suitable user interface construct for viewing the new information. As shown in FIGS. 29 and 30, in response to the user selecting “Info” button 2830 a second time, the interactive television program guide application may resize information window 2932 and the highlighted listing to provide the user with a lengthier segment of the additional information (as shown in FIG. 30). In response to the user selecting “Info” button 2830 a third time, the interactive television program guide application may remove information window 2932 for the highlighted listing from listings area 2606.

In some embodiments, the interactive television program guide application may allow the user to select the format of the news segments. For example, the user may select an option to display graphics within the news segment or may select an option to display the news segment in a text-only format.

In some embodiments, the interactive television program guide application may provide the user with real-time news information while the user is watching a television program. For example, while the user is watching a television program or browsing through program listings, the interactive television program guide application may display an news alert. In response to the user selecting the news alert, the interactive television program guide application may provide the user with real-time information relating to, for example, a breaking news story. Alternatively, the interactive television program guide application may allow the user to view the real-time news information while the user is watching a television program or browsing through program listings.

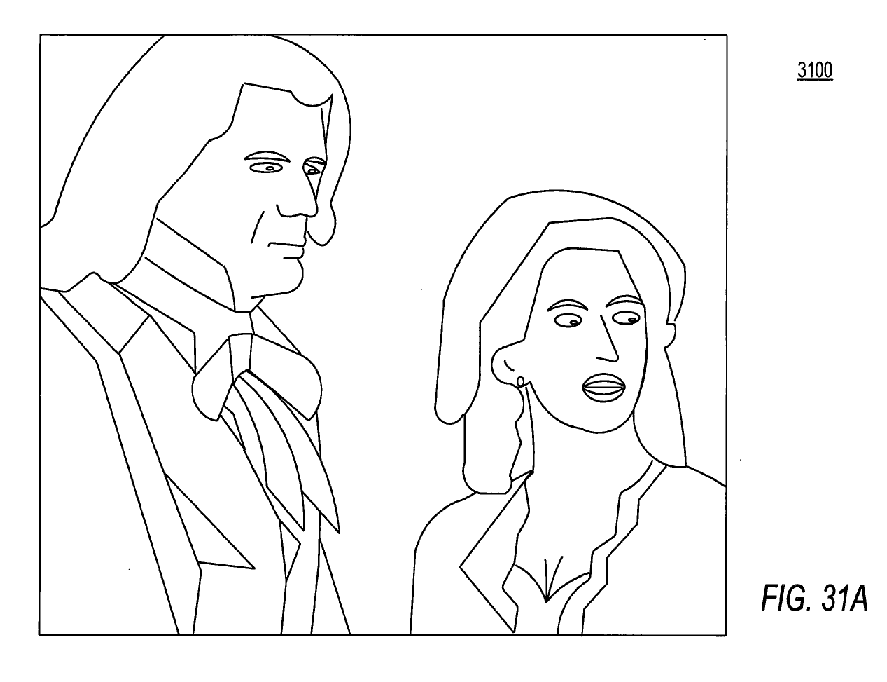

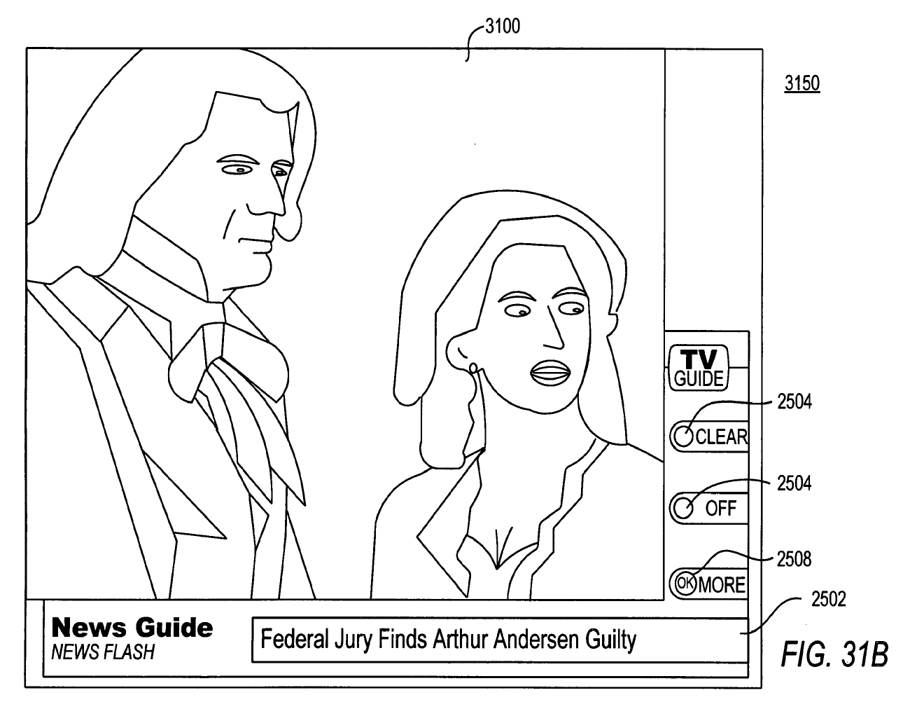

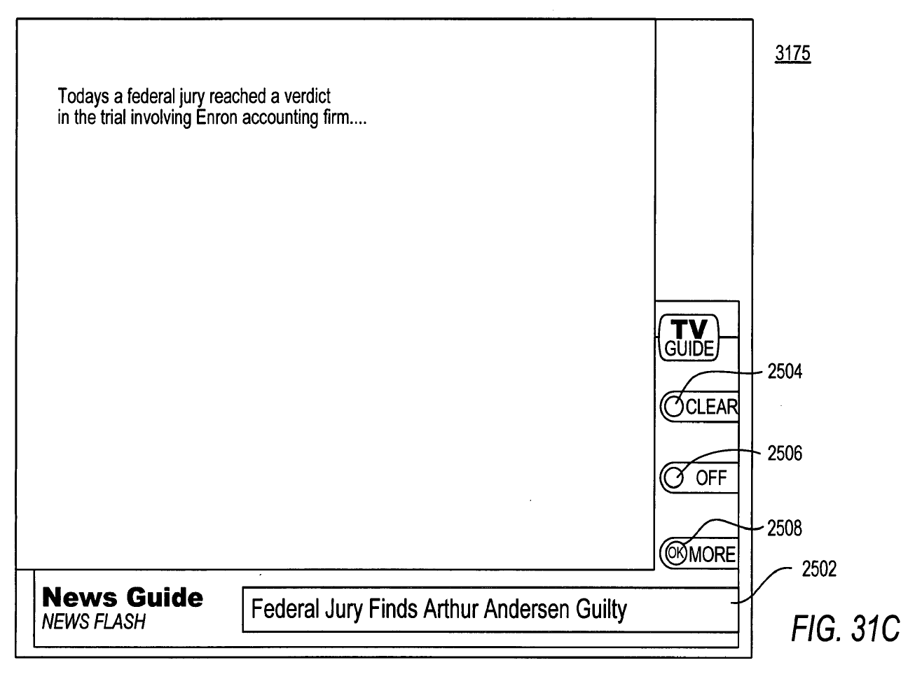

FIGS. 31A-31C show a news alert that the interactive television program guide application may provide to the user. An alert 2502 may be displayed in connection with the occurrence of a real-time news event. As shown in FIG. 31A, the user may be watching a television program in display screen 3100. In FIG. 31B, in response to the interactive television program guide application receiving a real-time news headline, the interactive television program guide application may provide the user with alert 2502. The interactive television program guide application may resize screen 3100 such that alert 2502 may be displayed without obscuring the television program. Alternatively, alert 2502 may be displayed in an overlay over the currently displayed program. Alert 2502 may also include information, such as promotional information and a headline, which may be selectable.

Alert 2502 may also provide the user with options, such as, for example, a clear alert button 2504, a turn off alert button 2506, and a more information button 2508. In response to the user selecting clear alert button 2504, the interactive television program guide application may remove alert 2502 from display screen 3150. In some embodiments, the interactive television program guide application may automatically remove alert 2502 from the screen after a predetermined amount of time (e.g., 30 seconds) has elapsed.

In response to the user selecting turn off alert button 2506, the interactive television program guide application may disable alert 2502. In response to the user selecting more information button 2508, the interactive television program guide application may display additional information relating to the alert.

Alert 2502 may be selectable by the user. In response to the user selecting alert 2502, the interactive television program guide application may provide the user with the real-time content related to alert 2502 (e.g., the news story). For example, as shown in FIG. 31C, the interactive television program guide application may provide the user with the “Federal Jury Finds Arthur Andersen Guilty” news story in response to the user selecting alert 2502.

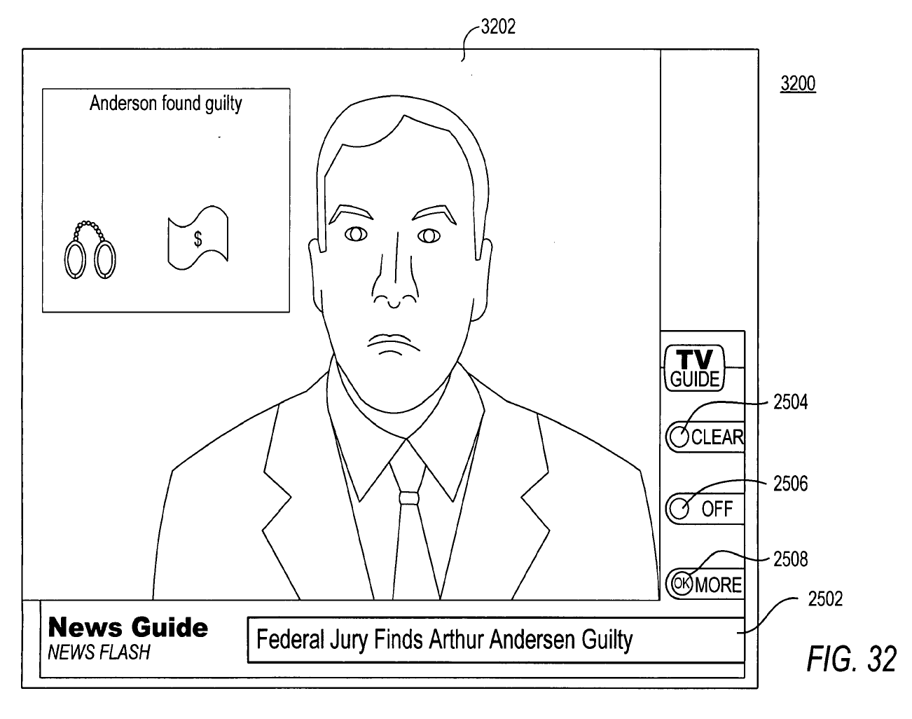

Alternatively, the interactive television program guide application may provide the user with a program relating to the alert. For example, as shown in FIG. 32, instead of providing the user with a text news story, the interactive television program guide application provides the user with a program that is currently discussing the topic of alert 2502 (e.g., CNN Headline News).

Weather information is also a type of real-time information that may be provided by the interactive television program guide application to users. Similarly, a listings region may be provided in which real-time weather information may be displayed. The interactive television program guide application may also provide the user with a weather alert. The weather alert may, for example, inform the user that a weather advisory or warning has been issued for the user's local area.

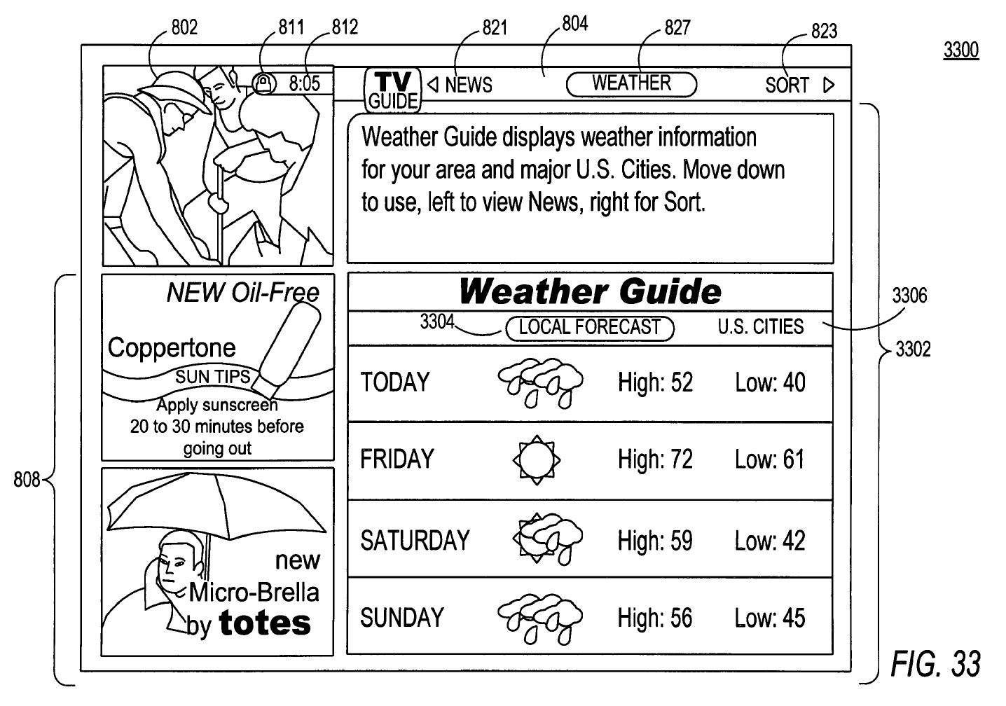

FIGS. 33-40 show illustrative real-time weather information screens that may be provided by the interactive television program guide application in accordance with various embodiments of the present invention. In the example of FIG. 33, the interactive television program guide application may provide the user with real-time weather information in response to the user, for example, selecting “Weather” service tab 827 from service navigation bar 804.

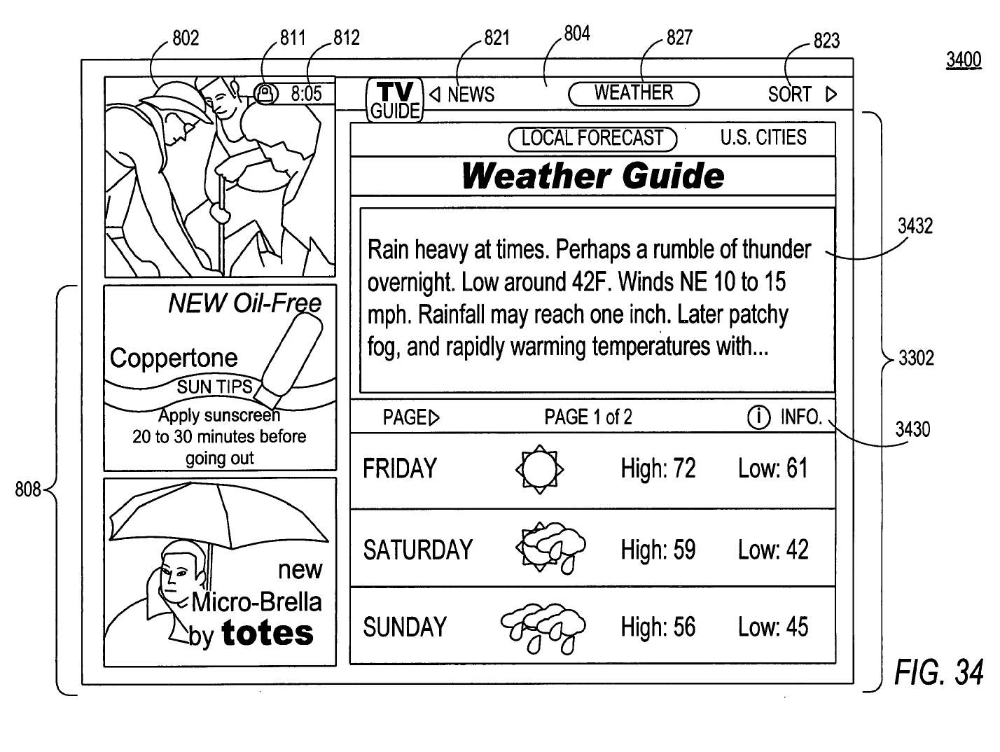

As shown in FIG. 34, the interactive television program guide application may provide the user with listings in listings area 3302. Each listing may include real-time weather information. In the example of FIG. 34, each listing relates to a particular day of the week and includes a weather forecast for the user's local area relating to the day of the week (e.g., in response to the user selecting a “Local Forecast” tab 3304). The real-time information provided with each listing in listings area 3302 may include, for example, the high and low temperature and the weather forecast. Any other suitable information may also be provided. For example, the interactive television program guide application may allow the user to view other weather-related information, such as the real-time humidity and the real-time pollen count for the user's local area.

In some embodiments, video window 802 may include a weather map showing weather conditions or a real-time video of current weather conditions (e.g., a live-feed showing precipitation at a park, etc.). In some embodiments, the real-time video may be displayed by tuning a tuner to a channel on which the real-time video is being broadcast. In other embodiments, the video clip may be retrieved from a database of real-time video clips.

Alternatively, a video clip of a general forecast may be provided if, for example, a video relating to the weather for the user's local area is unavailable. For example, the interactive television program guide application may display a program being broadcast on The Weather Channel.

The interactive television program guide application may also provide panel area 808 that includes advertisements for weather-related products such as, for example, suntan lotion and umbrellas (as shown in FIGS. 33-37).

In response to the user selecting “Info” button 3430 for a highlighted listing (e.g., a day of the week), the interactive television program guide application provides the user with a detailed forecast for the selected day in information window 3432 (FIG. 34). Information window 3432 may be positioned within the highlighted listing. Information window 3432 be positioned so as to not obstruct the view of the other listings.

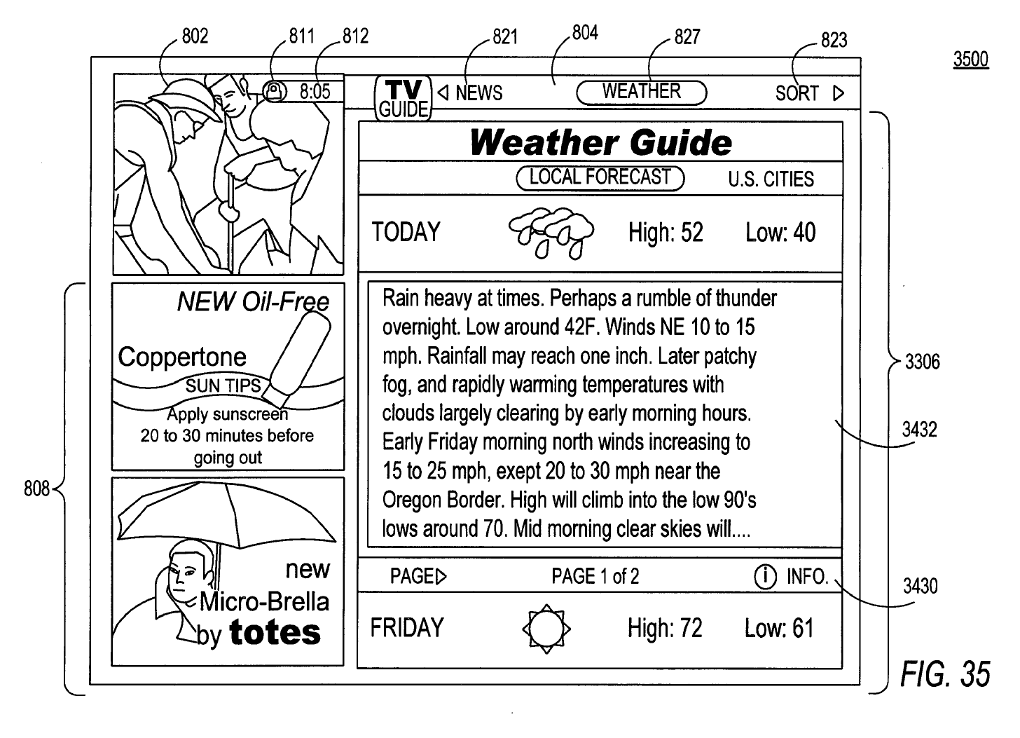

The interactive television program guide application may also provide the user with an option to view additional portions of the forecast. As shown in FIG. 35, in response to the user selecting “Info” button 3430 a second time, the interactive television program guide application resizes information window 3432 to provide the user with more text of the forecast. In another embodiment, scroll bars or any other suitable user interface construct may be provided to the user such that the user may view the entire forecast without navigating to additional segments of the forecast.

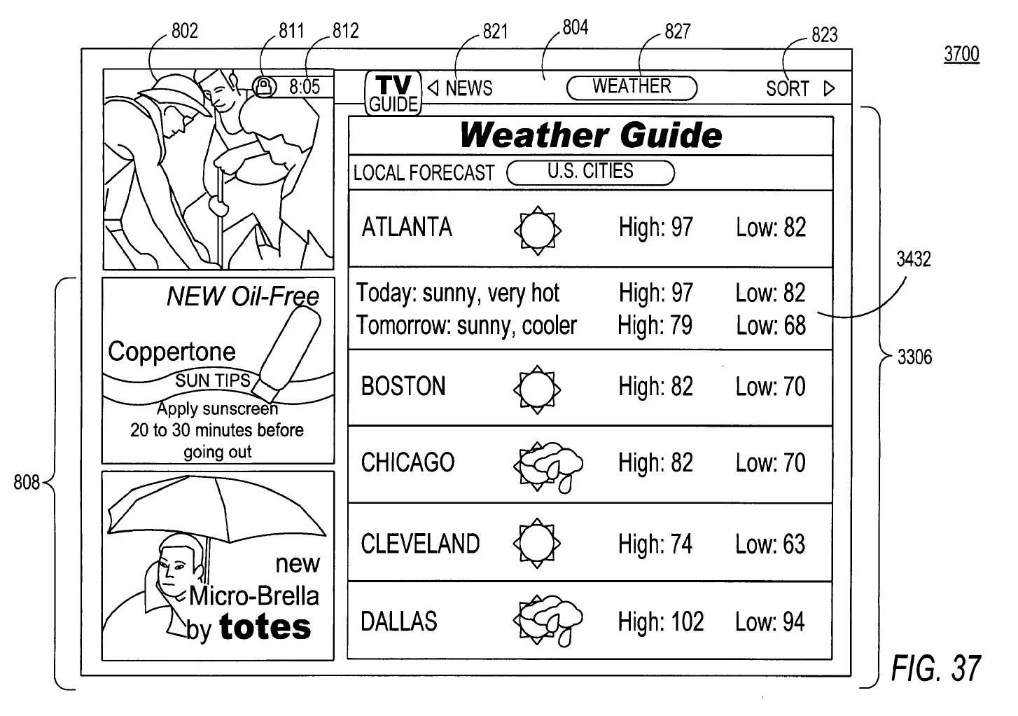

In FIG. 34, the interactive television program guide application may provide the user with current weather conditions for various cities (e.g., the twenty-five major cities of the United States) in response to the user selecting a “U.S. Cities” tab 3306. The high and low temperatures and the current weather condition for each city may be presented to the user. As shown in FIG. 37, in response to the user selecting a listing corresponding to a city, the interactive television program guide application may provide the user with a detailed forecast corresponding to the selected city. The detailed forecast may provide weather information for the selected city including high and low temperatures and the weather conditions for the present day and the next day.

Real-time weather information may be automatically provided to the user by displaying a weather alert. While the user is watching a television program or browsing through listings, the interactive television program guide application may display a real-time weather alert. In response to selecting the weather alert, the interactive television program guide application may provide the user with real-time information relating to the weather (e.g., a weather warning).

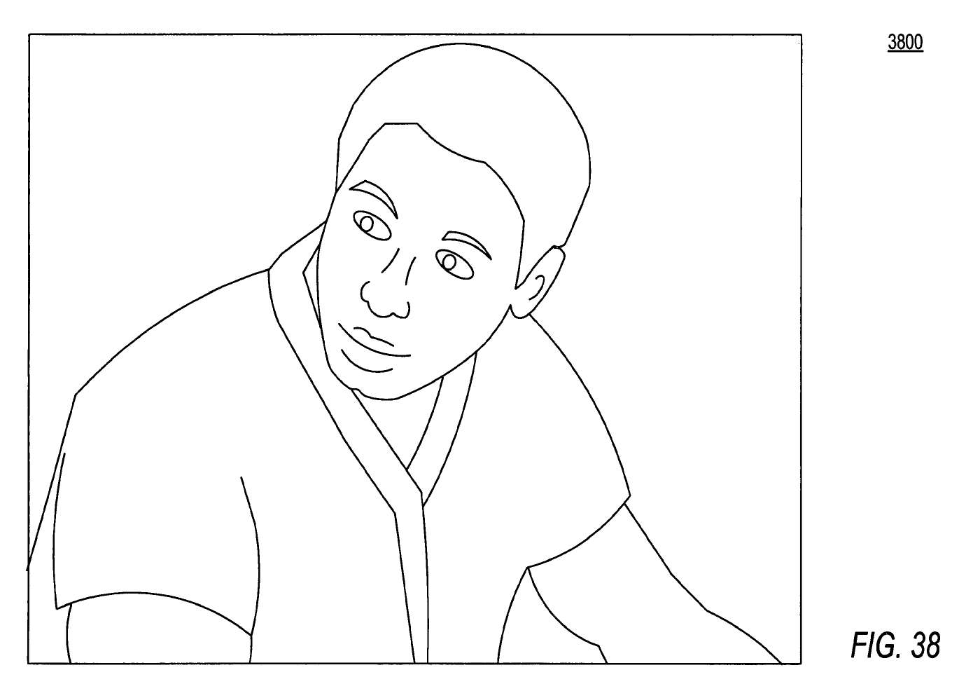

FIGS. 38-40 illustrate a weather alert that the interactive television program guide application may provide to the user in accordance with various embodiments of the present invention. For example, a weather alert may be displayed when a weather warning has been issued by the National Weather Service for the user's local area. While the user is watching a program (as shown in FIG. 38), the interactive television program guide application may provide the user with alert 2502 in response to the receiving the real-time weather warning.

Alert 2502 may also provide the user with options, such as, for example, a clear alert button 2504, a turn off alert button 2506, and a more information button 2508.

In response to the user selecting clear alert button 2504, the interactive television program guide application may remove alert 2502 from display screen 3900. In some embodiments, the interactive television program guide application may automatically remove alert 2502 from the screen after a predetermined amount of time (e.g., 30 seconds) has elapsed.

In response to the user selecting turn off alert button 2506, the interactive television program guide application may disable alert 2502. In response to the user selecting more information button 2508, the interactive television program guide application may display additional information relating to weather alert 2502.

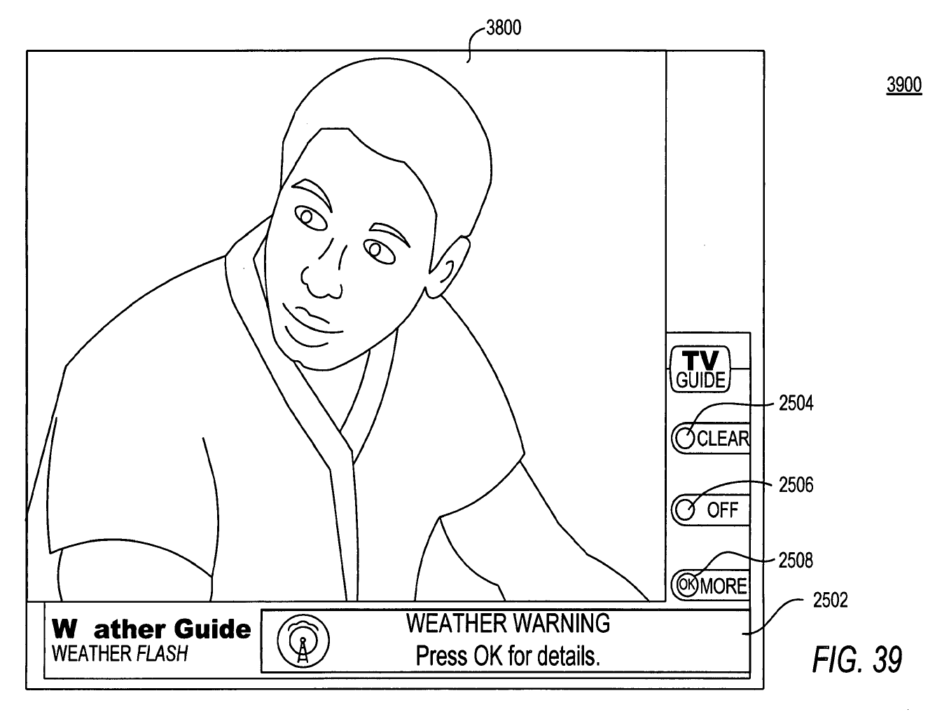

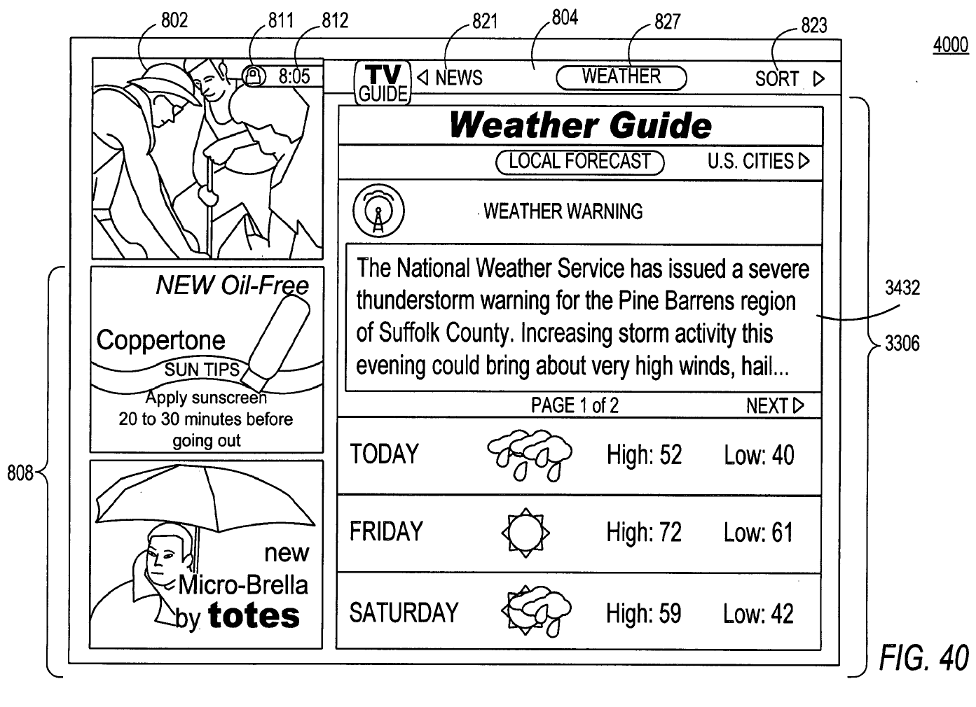

In some embodiments, alert 2502 may also be selectable by the user. For example, as shown in FIG. 39, the interactive television program guide application may allow the user to view the real-time weather warning by selecting the alert and pressing the “OK” key on the remote control. In response to the user selecting the alert, the interactive television program guide application may provide the user with the weather alert. For example, as shown in FIG. 40, the interactive television program guide application may provide the user with the weather warning in information window 3432. In another example, the interactive television program guide application may automatically tune the user equipment to a program that is discussing the weather warning.

In addition to real-time services, such as providing user with real-time sports scores, news, and weather information, the interactive television program guide application may also provide users with real-time financial information (e.g., stock market activity, account balances etc.), travel information (e.g., traffic conditions, airport delays, etc.), lottery results, and any other suitable information.

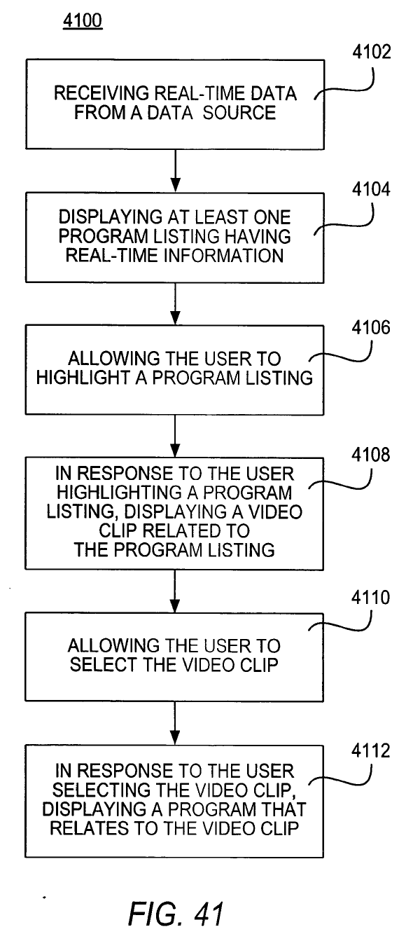

FIG. 41 is an illustrative method for displaying a video relating to a program listing having real-time information. At step 4102, the interactive television program guide application may receive real-time information from a data source, such as data source 30 (FIG. 2). Real-time information may include, for example, sports scores, stock quotes, news, weather, etc.

At step 4104, the interactive television program guide application may display program listings that include the received real-time information (e.g., FIG. 17). For example, the interactive television program guide application may provide a listings display that includes sports listings. Each listing may include real-time information, such as the current score, status of the game, sports news, etc. At step 4106, the interactive television program guide application may allow the user to highlight a program listing using, for example, a highlight region. For example, the user may position the highlight region over a given program listing.

In response to receiving a user indication that the user has highlighted a program listing, the interactive television program guide application may display a video clip related to the highlighted program listing (step 4108). For example, in response to the user highlighting the “Knicks vs. Celtics” game, the interactive television program guide application displays a real-time video clip of that game. In some embodiments, the interactive television program guide application may tune one of the tuners to a channel on which the highlighted program is currently being broadcast and display the currently broadcast program in a video window. Alternatively, the interactive television program guide application may retrieve the video clip from a database (e.g., at a data source, at a television distribution facility, at a main facility, on the user's digital video recorder, etc.) and display the video clip. For example, in response to the user highlighting the “Knicks vs. Celtics” game, the interactive television program guide application may retrieve a video clip for the selected listing from the database. Upon retrieving the video clip, the interactive television program guide application may automatically playback the video clip in a video window.

In some embodiments, the database may receive video clips and other information from the service provider. For example, the service provider may update the database by providing video clips for programs that have recently been broadcast. In another example, for upcoming programs, a service provider may transmit previews of the upcoming program or trailers to the database.

In some embodiments, the interactive television program guide application may retrieve video clips relating to programs that are about to be broadcast in anticipation of the user selecting a program listing for one of the upcoming programs. The interactive television program guide application may display the appropriate video clip in response to the user selecting the corresponding program listing. For example, the interactive television program guide application may retrieve video clips from the database for the upcoming programs “Fear Factor,” “7th Heaven,” and “Joe Millionaire” at 7:30 PM, before their 8:00 PM start times. In another example, the interactive television program guide application may retrieve video clips from the database for programs that the user is likely to watch or view program listings. In response to the user selecting the program listings for one of these programs, the corresponding video clip may be displayed.

In some embodiments, in response to the user selecting a program listing, the interactive television program guide application may retrieve the corresponding video clip and play back the video clip as it is being retrieved from the database. For example, the interactive television program guide application may display a video clip as a streaming video (i.e., displayed as it is being retrieved).

The video clip may also be selectable by the user. At step 4110, the interactive television program guide application may allow the user to select the video clip. In response to receiving a user indication that the user has selected the video clip (e.g., using the remote control), the interactive television program guide application may display a program that relates to the video clip at step 4112. For example, in response to the user selecting the video clip of the “Knicks vs. Celtics” game, the interactive television program guide application tunes the user equipment to the channel that is currently broadcasting the “Knicks vs. Celtics” game.

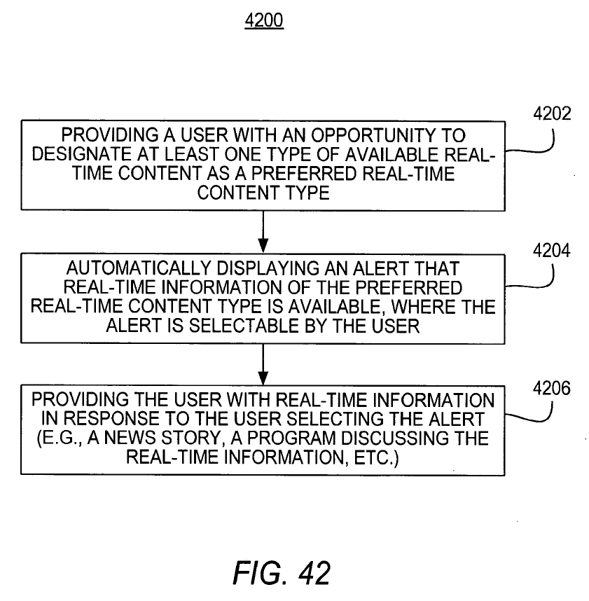

FIG. 42 shows an illustrative method for providing alerts and real-time information relating to the alert in accordance with various embodiments of the present invention. As described herein, the alert may relate to any suitable real-time information (e.g., news, sports, weather, etc.). At step 4202, the interactive television program guide application may provide a user with an opportunity to designate at least one type of available real-time content as a preferred real-time content type. For example, the user may designate the Boston Celtics basketball team as a preferred real-time content type. In another example, the user may designate business news as a preferred real-time content type. In yet another example, the user may designate weather warnings as a preferred real-time content type. To designate real-time content (e.g., the Boston Celtics), the interactive television program guide application may allow the user to select a “Flash” icon (e.g., FIG. 22).

At step 4204, in response to the user selecting one or more preferred real-time content types, the interactive television program guide application may automatically display an alert when real-time information of one of the preferred real-time content types is available. The interactive television program guide application may display the alert with the real-time information while the user is watching a program (e.g., FIG. 24A-24C). For example, if the user sets an alert for the “New York Giants,” the interactive television program guide application may provide the user with an alert when real-time content relating to the “New York Giants” is received by the interactive television program guide application.

The alert may be selectable by the user. At step 4206, in response to receiving a user indication that the user has selected the alert, the interactive television program guide application may provide the user with the real-time information. For example, in response to selecting a weather alert, the interactive television program guide application may provide the user with a weather warning or other information related to weather. In another example, in response to selecting an alert showing the current score for the “Giants vs. Jaguars” game, the interactive television program guide application may tune the user equipment to the channel that is currently broadcasting the “Giants vs. Jaguars” game.

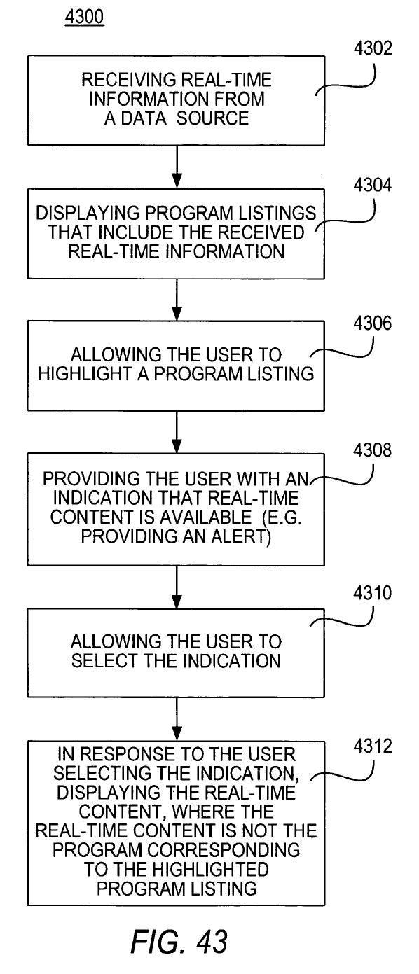

FIG. 43 is an illustrative method for indicating to the user that real-time content related to real-time information is available in accordance with various embodiments of the present invention. At step 4302, the interactive television program guide application may receive real-time information from a data source, such as data source 30 (FIG. 2).

At step 4304, the interactive television program guide application may display program listings that include real-time information. For example, the interactive television program guide application may provide the user with listings for basketball games. Each listing includes the real-time score for the corresponding basketball game.

At step 4306, the interactive television program guide application may allow the user to highlight a listing, using, for example, a highlight region. In response to receiving a user indication that user has highlighted a listing, the interactive television program guide application may provide the user with an indication that real-time content is available, wherein the real-time content is not the program that corresponds to the program listing (step 4308). For example, the interactive television program guide application may provide the user with an alert that real-time content is available. In another example, the interactive television program guide application may provide the user with an icon. However, any other suitable indicator may also be provided. For example, the interactive television program guide application may provide the user with a video clip of the real-time content that is not the program corresponding to the listing.

In some embodiments, the video clip of the real-time content may be obtained by tuning one of the tuners of the user's equipment to a channel on which the video clip is being broadcast. In some embodiments, the video clip of the real-time content may be obtained by retrieving the video clip from a database.

The indication may be selected by the user. At step 4310, the interactive television program guide application may allow the user to select the indication. In response to the user selecting the indication, the interactive television program guide application may display the real-time content at step 4312. For example, the interactive television program guide application may display real-time sports listings. In response to highlighting a sports listing, a video clip of the game corresponding to the sports listing is provided. The video clip may be retrieved from a database of video clips, or the interactive television program guide application may tune to a channel broadcasting the game. In response to selecting the video clip, the interactive television program guide application may provide the user with a program that is currently being broadcast and that is discussing the game. For example, the interactive television program guide application may tune one of the tuners in the user's equipment to a channel that is currently broadcasting the related program.

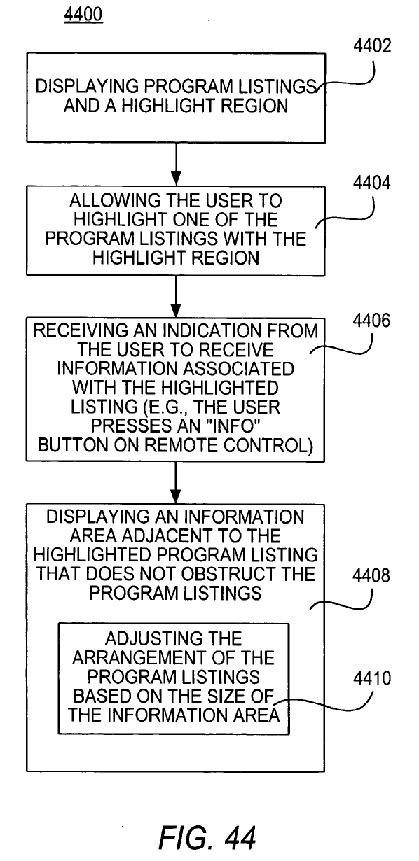

FIG. 44 is an illustrative method for displaying a program listing with an information window in accordance with various embodiments of the present invention. At step 4402, the interactive television program guide application may display a plurality of program listings and highlight region. At step 4404, the interactive television program guide application may allow the user to highlight one of the program listings with the highlight region. The user may highlight one of the program listings using, for example, the arrow buttons on the remote control. At step 4406, the interactive television program guide application may receive an indication from the user that the user wishes to receive information associated with the highlighted listing. For example, the user may press an “INFO” button or any other suitable pre-configured button on the remote control. In another example, the user may select an on-screen interface element (e.g., an “INFO” button). In response to highlighting one of the program listings with the highlight region, the interactive television program guide application may allow the user to receive information associated with the highlighted listing.

In response to receiving the indication from the user, the interactive television program guide application may display an information area, such as an information window, within the highlighted program listing such that it does not obstruct the other program listings at step 4408. Information area may include, for example, options related to the program (e.g., add the program to a favorites list, schedule a recording of the program, etc.) and/or information related to the program (e.g., a detailed description of the program and channel, a rating of the selected program, a progress bar, etc.).

The arrangement of the plurality of program listings in the program listings display may be adjusted based on the size of the information area at step 4410. For example, the interactive television program guide application may remove two program listings above the highlighted program listing and all but one program listing below the highlighted program listing to display the information area without obstructing the view of other program listings.

The foregoing is merely illustrative of the principles of this invention and various modifications can be made by those skilled in the art without departing from the scope and spirit of the invention.

1-13. (canceled)

14. A method for providing users with information using an interactive television program guide application, the method comprising:
accessing information from at least one real-time data feed, wherein the at least one real-time data feed provides information associated with at least one real-time event updated in response to changes in the at least one real-time event;
displaying at least one program listing comprising at least some of the information, wherein the at least one program listing corresponds to a program;
providing the user with an indication that content related to the information is available, wherein the indication is selectable and wherein the content is not the program that corresponds to the at least one program listing; and
in response to selecting the indication, displaying the content.

15. The method of claim 14 wherein the indication is a video clip.

16. The method of claim 14 wherein the indication is an icon.

17. The method of claim 14 wherein the indication is an alert.

18. The method of claim 14 further comprising allowing the user to remove the indication.

19. The method of claim 14 wherein displaying the content further comprises providing the user with a program that is currently being broadcast, and wherein the program that is currently being broadcast is discussing the information.

20-88. (canceled)

89. A system for providing users with information, the system comprising:
a user input interface;
a display device; and
an interactive television program guide application implemented at least partially on control circuitry configured to:
accessing information from at least one real-time data feed, wherein the at least one real-time data feed provides information associated with at least one real-time event updated in response to changes in the at least one real-time event;
display at least one program listing comprising at least some of the information, wherein the at least one program listing corresponds to a program;
provide the user with an indication that content related to the information is available, wherein the indication is selectable and wherein the content is not the program that corresponds to the at least one program listing; and
display the content in response to selecting the indication.

90. The system of claim 89 wherein the indication is a video clip.

91. The system of claim 89 wherein the indication is an icon.

92. The system of claim 89 wherein the indication is an alert.

93. The system of claim 89 wherein the control circuitry is further configured to allow the user to remove the indication.

94. The system of claim 89 wherein the control circuitry is further configured to provide the user with a program that is currently being broadcast, and wherein the program that is currently being broadcast is discussing the information.

95-100. (canceled)

101. The method of claim 14, further comprising buffering the accessed information by storing the information in a database.

102. The system of claim 89, wherein the control circuitry is further configured to buffer the accessed information by storing the information in a database.
